(19) United States
(12) Patent Application Publication
(10) Pub. No.: US 2024/0046322 A1
(43) Pub. Date: Feb. 8, 2024

(54) SYSTEM AND METHOD FOR MEDIA-AIDED CUSTOMER INTERACTION AND SALES

(71) Applicant: Vikram Seshadri, Portola Valley, CA (US)

(72) Inventor: Vikram Seshadri, Portola Valley, CA (US)

(21) Appl. No.: 17/880,694

(22) Filed: Aug. 4, 2022

(51) Int. Cl. G06Q 30/02; H04L 65/403

(52) U.S. Cl. CPC G06Q 30/0281; H04L 65/403

(57) ABSTRACT

A system including a sales interaction platform (SIP) and a method for executing a live interaction between a customer at a customer location and a sales entity at a retailer's physical location in real time to facilitate sales in a virtual environment, are provided. On receiving a request from a customer, the SIP matches the customer with a sales entity at the physical location by executing one or more matching algorithms. The SIP establishes a bidirectional, interactive media conferencing session (BIMCS) between the customer device and a sales device of the matched sales entity via a network. The SIP executes, through the BIMCS, one or more interactive sales activities (ISAs) substantially analogous to a physical interaction between customers and sales entities in real time. The ISAs include rendering auxiliary information with metadata that is uniquely identified with a sales identifier of the matched sales entity, to the customer device.

### BACKGROUND

The internet is a global network comprising a large number of computing devices and networks, that are connected together. The use of computing devices, for example, smartphones and tablets, continues to increase, and currently outnumber in sheer quantity the number of conventional computers or laptops. Smartphones, tablets, and other similar electronic devices are substantially beneficial due to their greatly increased portability, and are currently, therefore, almost ubiquitous. Each computing device on the internet, and often each user of a computing device, are uniquely identifiable through the use of various unique identifiers, for example, electronic mail (email) addresses, social media identities associated with internet-based social applications, etc., that are associated with their various online personas. The unique identifiers allow all users to also be uniquely identifiable consumers, both of services offered on the internet and as purveyors of physical goods that are sold through the internet.

The past decade has seen a rise of online retailers who use the internet to create virtual storefronts, reach consumers, and affect sales. In the recent past, these online retailers have achieved almost complete dominance of the current retail landscape because of their significantly lower operating costs. With no sales workers, no physical infrastructure to rent, pay for, or maintain, and no expenses such as electricity, insurance, and a myriad of other costs associated with maintaining a physical infrastructure, retailers such as online retailers and even retailers that have a physical infrastructure, have adopted the online sales model widely. The benefit to retailers on the internet is further enhanced by the fact that available inventory may be shown to customers irrespective of their physical locations, thereby invalidating the need to develop and maintain distribution channels, and locate physical items in close proximity to a customer in order to display the physical items to the customer. This allows a retailer to be able to maintain a substantially large number of products and have a much richer inventory, while simultaneously avoiding the additional expense of moving the available inventory to each physical location.

Shopping on the internet is further facilitated by the ease by which customers may browse merchandised items in a store, switch stores on the internet, and compare prices of the same or similar items between different stores. This online convenience has no physical equivalent, and provides a substantial advantage for the online storefront model, over a physical brick-and-mortar store. Sales people have become collateral damage of this movement to the online storefront model, and their continued role in the future of retail sales is currently being questioned. At question is the value that informed sales people provide to a sales process. Any clear answer to this question is obscured by the fact that there is not, often, a direct and linear correlation between a customer's interaction with a helpful and informed sales person and a subsequent sale, that may not immediately follow the interaction. Much of the financial pressure on brick-and-mortar stores is because their advantage in being the resource to interact with the customer does not convert to an equivalent sale, because of the propensity of the customer to take answers provided by sales people at the brick-and-mortar store, and shop for lower prices online.

Furthermore, the availability of video conferencing equipment and tools has also evolved significantly in the past decade. These equipment and tools have become a preferred method of communication for teams that are geographically distributed. Even at the consumer level, a large number of applications exist on the currently ubiquitous smartphones and tablets that allow video communication with relatively inexpensive hardware. There is a need for a system and a method for bringing together technology that is currently available, for example, the internet, communication technology and devices such as smartphones, tablets, video conferencing equipment and tools, etc., brick-and-mortar stores, and sales people who are employed at the brick-and-mortar stores, to create an optimal alternative to a physical interaction in a brick-and-mortar store, thereby, allowing customers to see, talk, and interact with the sales people in the brick-and-mortar store as they browse through the inventory, allowing for a real live exchange of information that significantly enhances the sales process and aids a customer's decision-making process at the same time.

Hence, there is a long-felt need for a system and a computer-implemented method for executing a live interaction between a customer at a customer location and a sales entity at a physical location of a retailer in real time to facilitate sales in a virtual environment.

### SUMMARY OF THE INVENTION

This summary is provided to introduce a selection of concepts in a simplified form that are further disclosed in the detailed description of the invention. This summary is not intended to determine the scope of the claimed subject matter.

The system and the computer-implemented method disclosed herein address the above-recited need for executing a live interaction between a customer at a customer location and a sales entity at a physical location of a retailer in real time to facilitate sales in a virtual environment. The system and the computer-implemented method disclosed herein allow a customer and one or more members of a sales team to interact with each other in a way that parallels and simulates a physical visit to a retail store, in order to facilitate a sales process. The system and the computer-implemented method disclosed herein bring together technology that is currently available, for example, the internet, communication technology and devices such as smartphones, tablets, video conferencing equipment and tools, etc., brick-and-mortar stores, and sales entities who are employed at the brick-and-mortar stores, to create an optimal alternative to a physical interaction in a brick-and-mortar store, thereby, allowing customers to see, talk, and interact with the sales entities in the brick-and-mortar store as they browse through inventory, allowing for a real live exchange of information that significantly enhances the sales process and aids a customer's decision-making process at the same time.

The system and the computer-implemented method disclosed herein employ a sales interaction platform for executing a live interaction between a customer at a customer location and a sales entity at a physical location, for example, a retail location or a display location, of a retailer in real time to facilitate sales in a virtual environment. The sales interaction platform is configured to contain information of all customers and sales entities of the retailer and allows the customers and the sales entities to be connected to each other. The system disclosed herein comprises multiple sales devices configured for use by the sales entities at the physical location of the retailer. The sales entities comprise sales persons employed at the physical location of the retailer to serve physical customers who visit the physical location of the retailer and virtual customers who contact the sales entities via the sales interaction platform. In an embodiment, each of the sales devices is a dedicated computing device comprising one or more cameras and a microphone, configured to connect the sales entities to the sales interaction platform via a network, for example, the internet. The sales interaction platform is communicatively coupled to multiple sales devices associated with the sales entities and to multiple customer devices associated with customers, via a network, for example, the internet. In an embodiment, the sales interaction platform is configured as a server comprising at least one processor, a memory unit operably and communicatively coupled to the processor(s), one or more databases, and one or more modules defining computer program instructions executable by the processor(s) for executing a live interaction between a customer at a customer location and a sales entity at a physical location of a retailer in real time to facilitate sales in a virtual environment. The memory unit is configured to store the computer program instructions executable by the processor(s). The database(s) is configured to store customer information, sales entity information, sales device information, and information on the live interaction between the sales entities and the customers.

In the system and the computer-implemented method disclosed herein, the sales interaction platform receives a request for communication from one of the customer devices associated with one of the customers at the customer location, via the network. In an embodiment, the sales interaction platform receives a user action on a user interface rendered by the retailer in the virtual environment, as the request for communication. The sales interaction platform matches the customer at the customer location with one of the sales entities at the physical location of the retailer by executing one or more matching algorithms. The matching algorithms are computer algorithms comprising, for example, machine learning algorithms, deep learning algorithms, and other artificial intelligence (AI) and non-AI algorithms. The matching algorithm(s) defines criteria configured to match the customer at the customer location with one of the sales entities at the physical location of the retailer. The criteria based on which the matching is performed comprise, for example, availability criteria of the sales entities and suitability criteria of the sales entities. The suitability criteria comprise, for example, one or more of domains of expertise of the sales entities, the physical location of the retailer, the customer location, geographical location of the sales entities, interaction history, proximity of the sales entities to the customer location of the customer determined using global positioning system (GPS) data, department of a merchandised item of interest derived from a unique item identifier, the customer information, demographic information, historical information of previous bidirectional, interactive media conferencing sessions conducted between the customer and a corresponding one of the sales entities, preferences of the customers and the sales entities, etc. The historical information of the previous bidirectional, interactive media conferencing sessions comprises, for example, number and/or length of the previous bidirectional, interactive media conferencing sessions. In an embodiment, the suitability criteria comprise two or more of the above listed criteria.

The sales interaction platform establishes a bidirectional, interactive media conferencing session between the customer device at the customer location and one of the sales devices associated with the matched sales entity at the physical location of the retailer via the network. The bidirectional, interactive media conferencing session is, for example, one of an interactive video conferencing session, an interactive audioconferencing session, an interactive audio-visual conferencing session, an interactive visual conferencing session with a textual translation of audio content, and an interactive multimedia conferencing session. In an embodiment, the sales interaction platform renders an interface element associated with each of multiple merchandised items managed by the retailer on the user interface rendered by the retailer in the virtual environment. On receiving a user action on the interface element associated with any of the merchandised items displayed on the user interface, the sales interaction platform establishes the bidirectional, interactive media conferencing session associated with that merchandised item between the customer device at the customer location and the sales device at the physical location of the retailer via the network.

The sales interaction platform executes, through the bidirectional, interactive media conferencing session, one or more of multiple interactive sales activities substantially analogous to a physical interaction between the customers and the sales entities at the physical location of the retailer in real time. The interactive sales activities are configured to enhance the sales and aid decision-making of the customers. The interactive sales activities comprise rendering auxiliary information with metadata configured to be uniquely identified with a unique sales identifier of the matched sales entity, to the customer device. In an embodiment, the interactive sales activities further comprise a bidirectional question-answer session between the customer and the matched sales entity. In another embodiment, the interactive sales activities further comprise bidirectional communication and exchange of sales information related to merchandised items, promotions, and offers of the retailer between the customer and the matched sales entity. In another embodiment, the interactive sales activities further comprise interactive viewing, by the customer, of the merchandised items managed by the retailer.

In another embodiment, the interactive sales activities further comprise customer engagement activities associated with the auxiliary information comprising, for example, one or more of promotional coupons, alternative product recommendations, product media, ratings, studies, online product research and discovery elements such as webpages, hyperlinks, and media content, etc., to engage the customer. In an embodiment, the promotional coupons are personalized, time-limited coupons. In an embodiment, the sales interaction platform tracks and links usage of the promotional coupons by the customer to the bidirectional, interactive media conferencing session using the metadata.

In an embodiment, the system disclosed herein further comprises a client application deployed on each of the customer devices, which is hereinafter referred to as a “customer application”. The customer application is configured to identify each of the customers to the sales interaction platform through a unique customer identifier assigned to the customer application. The sales interaction platform establishes the bidirectional, interactive media conferencing session via an electronic media link between the customer application on the customer device and a client application deployed on the sales device of the matched sales entity for bidirectional interactivity therebetween. The client application deployed on a sales device of a sales entity is hereinafter referred to as a “sales application”. When the bidirectional, interactive media conferencing session is established via the electronic media link between the customer application on the customer device and the sales application deployed on the sales device, the sales interaction platform launches an application interface on the customer device and the sales device. In an embodiment, the application interface comprises one or more of multiple configurable areas comprising a video area, a data area, a tools area, and other optional and additional areas that provide additional functional capabilities for interaction and communication between the customer and the sales entity. The video area is configured to allow the customer and the matched sales entity to view each other. The data area is configured to allow exchange of information, for example, sales information, auxiliary information, etc., that supports a conversation between the customer and the matched sales entity. The tools area is configured to assist the exchange of the information in the data area, enhance bidirectional communication between the customer and the matched sales entity, add other sales entities and other customers to the bidirectional, interactive media conferencing session, and complete a transaction. In an embodiment, the configurable areas further comprise a coupons area configured to manage coupons with associated unique sales identifiers transferred by the matched sales entity to the customer. In an embodiment, the sales interaction platform utilizes the unique customer identifier to: (a) connect to the identified customer at any time; and (b) store the customer information and the information of the live interaction between the customer and the matched sales entity.

In an embodiment, the sales interaction platform allows the matched sales entity to add another one or more of the sales entities to the bidirectional, interactive media conferencing session to assist the matched sales entity; and/or to provide expertise of the other one or more sales entities in the live interaction with the customer. In an embodiment, the sales interaction platform allows the matched sales entity to transition the bidirectional, interactive media conferencing session to the added sales entities. In another embodiment, the sales interaction platform allows the customer to add another one or more customers to the bidirectional, interactive media conferencing session to allow the matched sales entity to interact with multiple customers simultaneously and execute one or more of the interactive sales activities identically across the multiple customers.

In an embodiment, the sales interaction platform identifies and tracks each of the sales entities through a unique sales identifier assigned thereto. The sales interaction platform utilizes the unique sales identifier to collect and store the sales entity information comprising geographical locations of each of the sales entities, one or more departments, one or more areas of expertise, and a complete history of interactions of each of the sales entities with the customers. The complete history of interactions comprises, for example, information about coupons, discounts, special offers, considerations that have been advanced to the customers by each of the sales entities, and associated customer redemption information. In another embodiment, the sales interaction platform identifies and tracks each of the sales devices through a unique device identifier assigned thereto. The sales interaction platform utilizes the unique device identifier to check whether each of the sales devices is connected to the sales interaction platform. The sales interaction platform also utilizes the unique device identifier for contacting each of the sales devices at any time. In an embodiment, the sales interaction platform determines which sales device is being used by each sales entity. In an embodiment, the sales interaction platform determines effectiveness of the sales entities for training the sales entities, enhancing the effectiveness of the sales entities in communicating with the customers, and tracking continued improvement of the sales entities.

The embodiments disclosed herein comprise several interrelated components and steps, and the relation of one or more of such steps with respect to each of the other steps, the combination of elements, and the arrangement of components that are adapted to affect such steps, are all exemplified in the following detailed disclosure. In one or more embodiments, related systems comprise circuitry and/or programming for executing the methods disclosed herein. The circuitry and/or programming comprise one or any combination of hardware, software, and/or firmware configured to execute the methods disclosed herein depending upon the design choices of a system designer. In an embodiment, various structural elements are employed depending on the design choices of the system designer.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific components and methods disclosed herein. The description of a component or a method step referenced by a numeral in a drawing is applicable to the description of that component or method step shown by that same numeral in any subsequent drawing herein.

FIG. 1 illustrates an architectural block diagram of an exemplary implementation of a system for executing a live interaction between a customer at a customer location and a sales entity at a physical location of a retailer in real time to facilitate sales in a virtual environment.

FIG. 2 illustrates a flowchart of an embodiment of a computer-implemented method for executing a live interaction between a customer at a customer location and a sales entity at a physical location of a retailer in real time to facilitate sales in a virtual environment.

FIG. 3 exemplarily illustrates a flowchart of an embodiment of a method for matching a customer at a customer location with a sales entity at a physical location of a retailer and executing a bidirectional, interactive audio-video session therebetween in real time.

FIG. 4 exemplarily illustrates a flowchart of an embodiment of a method for executing a bidirectional, interactive audio-video session between a customer at a customer location and a sales entity at a physical location of a retailer in real time to facilitate sales in a virtual environment.

FIG. 5 exemplarily illustrates an embodiment of a database schema showing logical connections between different database tables implemented in the system for executing a live interaction between a customer at a customer location and a sales entity at a physical location of a retailer in real time to facilitate sales in a virtual environment.

FIG. 6 exemplarily illustrates a screenshot of a portion of a webpage of a retailer, displaying a list of merchandised items and an interface element disposed proximal to each of the merchandised items for triggering a bidirectional, interactive media conferencing session.

FIGS. 7A-7B exemplarily illustrate different arrangements of configurable areas of an application interface launched on a customer device and a sales device for executing a live interaction between a customer at a customer location and a sales entity at a physical location of a retailer in real time to facilitate sales in a virtual environment.

### DETAILED DESCRIPTION OF THE INVENTION

Various aspects of the disclosure herein are embodied as a system, a method, or a non-transitory, computer-readable storage medium having one or more computer-readable program codes stored thereon. Accordingly, various embodiments of the disclosure herein take the form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”.

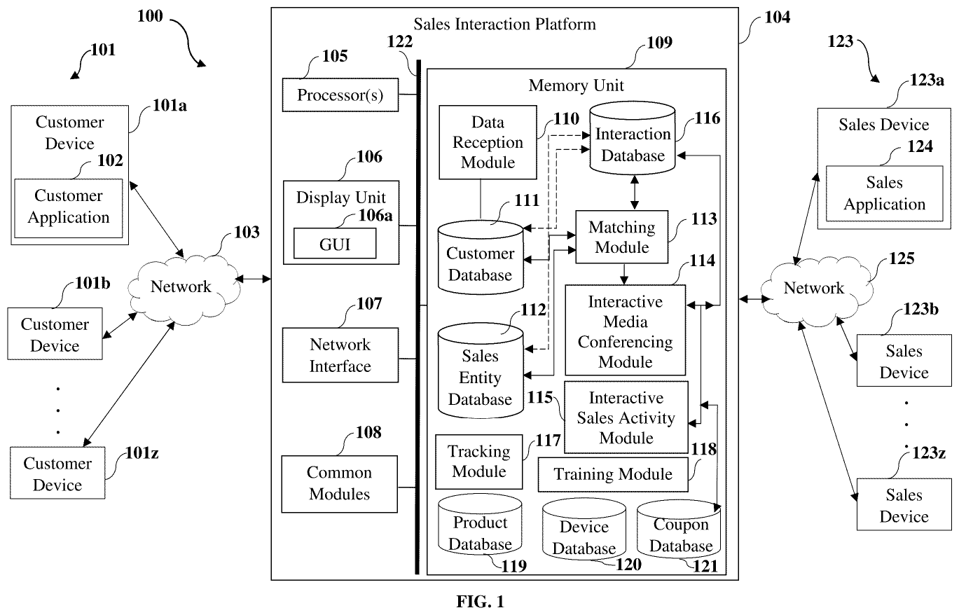

FIG. 1 illustrates an architectural block diagram of an exemplary implementation of a system 100 for executing a live interaction between a customer at a customer location and a sales entity at a physical location of a retailer in real time to facilitate sales in a virtual environment. As used herein, “sales entity” refers to an individual, for example, a sales person, a sales associate, a sales agent, a retail agent, a sales executive, a sales representative, etc., employed at the physical location of the retailer to serve physical customers who visit the physical location of the retailer and virtual customers who contact sales entities via a sales interaction platform 104 of the system 100 disclosed herein. In an embodiment, the sales entity is an artificial intelligence (AI)-powered robot configured to serve physical and/or virtual customers. In another embodiment, the sales entity is a videobot configured similar to a chatbot and powered by AI. The physical location is a physical brick-and-mortar store location, for example, a retail store location, a display location of the retailer, a video call center location set up similar to a store, etc. The video call center may be located at a remote geographical area or at any location in the world, for handling a support call, for example, an audio-video call, between the customer and the sales entity.

Also, as used herein, the term “retailer” refers to an individual or an organization, for example, a grocery store, a pharmacy, a clothing store, a bank, or other retail outlets that offer merchandised items such as products, services, etc., and manage sale of the merchandised items to customers. The retailer is, for example, an online retailer, a retailer maintaining a physical infrastructure, etc. Also, as used herein, “virtual environment” refers to an online environment where users of computing devices that are geographically distributed at different locations, communicate with each other over a network 103, for example, the internet. Also, as used herein, the term “user” refers to a customer who wishes to purchase merchandised items from the retailer and may want to engage in a media-aided, live interaction with a sales entity at the physical location of the retailer in real time. The media-aided, live interaction refers to a live interaction aided by media devices such as customer devices and sales devices disclosed below and by media, for example, video, audio, etc., and comprising two-way or multipoint communication of media signals, for example, video signals and/or audio signals, between a customer at the customer location and the sales entity at the physical location of the retailer in real time.

The system 100 disclosed herein employs the sales interaction platform 104 for executing a live interaction between a customer at a customer location and a sales entity at a physical location of a retailer in real time to facilitate sales in a virtual environment. The system 100 disclosed herein comprises multiple sales devices 123a, 123b, 123z, etc., configured for use by sales entities at the physical location of the retailer. In an embodiment, each of the sales devices 123a, 123b, 123z, etc., is a specialized, dedicated computing device comprising one or more cameras and a microphone, configured to connect the sales entities to the sales interaction platform 104 via the network 125, for example, the internet. In an embodiment, the sales devices 123a, 123b, 123z, etc., are owned by the retailer and issued to the sales entities employed by the retailer. The sales devices 123a, 123b, 123z, etc., are specifically configured to allow the sales entities to connect to the sales interaction platform 104 and form a substantial part of the connectivity between the customer(s) and the sales entities. In an embodiment, each of the sales devices 123a, 123b, 123z, etc., is designed and built specifically for the purpose of executing a live interaction between a customer at a customer location and a sales entity at a physical location of a retailer in real time to facilitate sales in a virtual environment. In another embodiment, each of the sales devices 123a, 123b, 123z, etc., is built out of commodity mobile computing hardware that is commercially available. The sales devices 123a, 123b, 123z, etc., are configured to be carried by the sales entities while the sales entities walk around the physical location of the retailer, for example, a physical store of the retailer. In an embodiment, each of the sales devices 123a, 123b, 123z, etc., comprises multiple cameras to allow the sales entities to switch between the cameras while talking to the customer(s) and showing the customer(s) merchandised items on a store shelf at the physical store.

Each of the sales devices 123a, 123b, 123z, etc., is configured with suitable hardware that allows connection to the network 125, for example, the internet; that provides a form factor suitable for mobile operation; that supports one or more screens or sub-screens configured to display different information; that provides an electronic media link, for example, an audio-video link that establishes a bidirectional, interactive media conferencing session between one of multiple customer devices 101a, 101b, 101z, etc., and one of the sales devices 123a, 123b, 123z, etc.; and that comprises one or more cameras configured to be used either together or separately by a sales entity. In an embodiment, the sales devices 123a, 123b, 123z, etc., are configured similar to smartphones, tablet computing devices, etc., implemented on different platforms, for example, the Android platform of Google LLC, the iOS platform of Apple, Inc., the Windows® platform of Microsoft Corporation, etc. The retailer provides the sales devices 123a, 123b, 123z, etc., to the sales entities in a retail store, and each of the sales devices 123a, 123b, 123z, etc., and the sales entities are assigned unique identifiers that allow them to be tracked in the sales interaction platform 104. The sales devices 123a, 123b, 123z, etc., register with the sales interaction platform 104 and stand ready to be connected to a customer at any time. Each of the sales devices 123a, 123b, 123z, etc., is uniquely identified in the system 100 by the use of a unique device identifier. The sales interaction platform 104 utilizes the unique device identifier of each of the sales devices 123a, 123b, 123z, etc., to check whether the corresponding sales devices 123a, 123b, 123z, etc., are connected to the sales interaction platform 104, and to allow the sales devices 123a, 123b, 123z, etc., to be contacted by the sales interaction platform 104 at any time.

The sales interaction platform 104 is accessible to the sales entities through a broad spectrum of technologies and the sales devices 123a, 123b, 123z, etc., issued by the retailer. The sales interaction platform 104 is communicatively coupled to the sales devices 123a, 123b, 123z, etc., associated with the sales entities via the network 125. Each sales entity may login to the sales interaction platform 104, for example, using their unique sales identifier or any other authentication mechanism provided by the retailer to each sales entity. In an embodiment, the sales interaction platform 104 stores security credentials of the sales entities in a sales entity database 112. The sales interaction platform 104 utilizes the stored security credentials to authenticate the sales entities upon request. Once authenticated, the sales entity is associated with one of the sales devices 123a, 123b, 123z, etc., till the sales entity logs out and severs their association with the associated sales device 123a, 123b, or 123z. The sales interaction platform 104 is also communicatively coupled to multiple customer devices 101a, 101b, 101z, etc., associated with customers, via the network 103. The sales interaction platform 104 is accessible to the customers through a broad spectrum of technologies and the customer devices 101a, 101b, 101z, etc. The customer devices 101a, 101b, 101z, etc., are electronic devices, for example, one or more of personal computers with access to the internet, tablet computing devices, mobile computers, mobile phones, internet-enabled cellular phones, smartphones, portable computing devices, laptops, personal digital assistants, wearable computing devices such as smart glasses, smart watches, etc., touch-centric devices, workstations, client devices, portable electronic devices, network-enabled computing devices, interactive network-enabled communication devices, gaming devices, televisions, image capture devices, devices capable of running web browsers, any other suitable computing equipment, combinations of multiple pieces of computing equipment, etc.

In an embodiment, the system 100 disclosed herein further comprises a client application deployed on each of the customer devices 101a, 101b, 101z, etc., which is hereinafter referred to as a customer application 102. The customer application 102 is configured to identify each of the customers to the sales interaction platform 104 through a unique customer identifier assigned to the customer application 102. The unique customer identifier uniquely identifies each customer on the internet, for example, to a retail store on an online shopping website. In an embodiment, the sales interaction platform 104 assigns a unique customer identifier to every customer in the system 100, which serves to uniquely identify each customer and to establish a connection to each customer from the sales interaction platform 104 at any time, if required. The customer application 102 on each of the customer devices 101a, 101b, 101z, etc., is configured to transmit the unique customer identifier assigned thereto along with a request for communication with a sales entity, to the sales interaction platform 104 via the network 103. The customer devices 101a, 101b, 101z, etc., with their respective deployed customer applications 102 constitute a customer system 101 in the system 100 disclosed herein. In an embodiment, the customer application 102 is a browser-based application implemented, for example, as an application that runs within a browser installed on each of the customer devices 101a, 101b, 101z, etc. In another embodiment, the customer application 102 is implemented as an application on the Android® platform of Google Inc., the iOS platform of Apple Inc., the Windows® platform of Microsoft Corporation, or any other functionally equivalent platform deployed on each of the customer devices 101a, 101b, 101z, etc.

In another embodiment, the sales interaction platform 104 establishes a bidirectional, interactive media conferencing session between a customer device at the customer location and a sales device associated with a sales entity at the physical location of the retailer via respective networks 103 and 125, without assigning a unique customer identifier to the customer. Similar to an unidentified customer walking into the physical location of the retailer where a sales entity is unaware of the customer's identity, in this embodiment where the customer is unknown and unidentified, the sales interaction platform 104 assigns a temporary identifier, for example, a unique session identifier, to the unidentified customer for a particular bidirectional, interactive media conferencing session, using minimal information about the customer to allow the bidirectional communication to be established between the customer and the sales entity. In this embodiment, as the sales interaction platform 104 is unaware of the identity of the customer, the sales interaction platform 104 cannot contact the customer back at any time. For a particular bidirectional, interactive media conferencing session, the sales interaction platform 104 assigns the temporary identifier to the unidentified customer, which does not persist until and unless the customer chooses, for example, to log into a retail store website provided by the retailer and identify themselves. The sales interaction platform 104 allows the customer to choose to authenticate themselves on the retail store web site, prior to initiating the bidirectional, interactive media conferencing session, in which case, the sales interaction platform 104 determines the identity of the customer and assigns a unique customer identifier to the customer. The unique customer identifier assigned to the customer serves to uniquely identify the customer and establish a connection to the customer from the sales interaction platform 104 at any time. If the customer chooses not to identify themselves, then the sales interaction platform 104 generates a new unique session identifier for each individual interaction between an unidentified customer and the sales entity.

Furthermore, the system 100 disclosed herein further comprises a client application deployed on each of the sales devices 123a, 123b, 123z, etc., which is hereinafter referred to as a sales application 124. The sales application 124 is configured to identify each of the sales entities to the sales interaction platform 104 through a unique sales identifier assigned to the sales application 124. The sales application 124 defines computer program instructions executable by at least one processor of each of the sales devices 123a, 123b, 123z, etc., and is configured to run in a background environment of each of the sales devices 123a, 123b, 123z, etc. The sales application 124 is configured to receive a connection request from the sales interaction platform 104 while running in the background environment. When the sales application 124 receives the connection request, the sales application 124 launches itself into a foreground environment of the sales device 123a, 123b, or 123z, and completes the connection or prompts the sales entity to accept initiation of a bidirectional, interactive media conferencing session in the form of a media call, for example, an audio-video call. The unique sales identifier uniquely identifies each sales entity employed by the retailer, for example, to the retail store on the online shopping website.

In an embodiment, the sales entities who are associated with and form a part of the system 100, register with the sales interaction platform 104. On registration with the sales interaction platform 104, the sales interaction platform 104 assigns a unique sales identifier to each of the sales entities. This unique sales identifier allows relevant information about each sales entity, for example, their physical location, department, area(s) of expertise, a complete history of all their interactions with customers, etc., to be collected and stored within the sales interaction platform 104. The complete history of their interactions comprises, for example, information about any coupons, discounts, special offers, or other considerations that have been advanced to the customer by the sales entity, as well as associated information about redemption of the coupons, offers, etc., by the customer. The sales interaction platform 104 stores the relevant information about each sales entity in a sales entity database 112. Each sales entity located at the physical location of the retailer, for example, a physical store, is employed to serve both physical customers who visit the physical store, as well as customers who contact the sales entity through the sales interaction platform 104 and request assistance of any kind. The sales application 124 on each of the sales devices 123a, 123b, 123z, etc., is configured to transmit the unique sales identifier assigned to a sales entity matched by the sales interaction platform 104 for communicating with the customer, along with a unique device identifier assigned to a corresponding one of the sales devices 123a, 123b, 123z, etc., associated with the matched sales entity, to the sales interaction platform 104 via the network 125. The sales devices 123a, 123b, 123z, etc., with their respective deployed sales applications 124 constitute a sales entity system 123 in the system 100 disclosed herein. In an embodiment, the sales entity system 123 that deploys the sales application 124 is configured to run a single operating system or different operating systems, for example, the Android® operating system of Google LLC, the iOS operating system of Apple, Inc., the Windows® operating system of Microsoft Corporation, or any other functionally equivalent operating system.

The sales interaction platform 104 is a computer system programmable using high-level computer programming languages. In an embodiment, the sales interaction platform 104 is implemented on an electronic device, for example, a workstation, one or more servers, a network-enabled computing device, an interactive network-enabled communication device, any other suitable computing equipment, combinations of multiple pieces of computing equipment, etc. In another embodiment, the sales interaction platform 104 is implemented in a cloud computing environment. As used herein, “cloud computing environment” refers to a processing environment comprising configurable, computing, physical, and logical resources, for example, networks, servers, storage media, virtual machines, applications, services, etc., and data distributed over the network 125. The cloud computing environment provides an on-demand network access to a shared pool of the configurable, computing, physical, and logical resources. In an embodiment, the sales interaction platform 104 is a cloud-based platform implemented as a service for executing a live interaction between a customer at a customer location and a sales entity at a physical location of a retailer in real time to facilitate sales in a virtual environment. For example, the sales interaction platform 104 is configured as a software as a service (SaaS) platform or a cloud-based software as a service (CSaaS) platform that executes a live interaction between a customer at a customer location and a sales entity at a physical location of a retailer in real time to facilitate sales in a virtual environment. In another embodiment, the sales interaction platform 104 is implemented locally as an on-premise platform comprising on-premise software installed and run on client systems on the premises of an organization, for example, a retail store, a bank, etc., to meet privacy and security requirements.

The networks 103 and 125 that connect the customer devices 101a, 101b, 101z, etc., and the sales devices 123a, 123b, 123z, etc., respectively, to the sales interaction platform 104 are short-range networks or long-range networks. For example, each of the networks 103 and 125 is one of: the internet, satellite internet, an intranet, a wired network, a wireless network, a communication network that implements Bluetooth® of Bluetooth Sig, Inc., a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. The sales interaction platform 104 interfaces with the customer devices 101a, 101b, 101z, etc., and the special-purpose dedicated sales devices 123a, 123b, 123z, etc., and in an embodiment, with one or more database systems (not shown) and servers (not shown) to implement the live interaction service, and therefore more than one specifically programmed computing system is used for implementing the live interaction service. In an embodiment, the sales interaction platform 104, the customer devices 101a, 101b, 101z, etc., and the sales devices 123a, 123b, 123z, etc., constitute interconnected components of the system 100 that are deployed at different locations, but all coordinate with each other through their respective networks 103 and 125, to provide an improvement in customer interaction and sales by creating an optimal alternative to a physical interaction in a brick-and-mortar store.

In an embodiment, the sales interaction platform 104 is configured as a server in a cloud computing platform, for example, the Amazon Web Services (AWS®) platform of Amazon Technologies, Inc., the Microsoft Azure ° platform of Microsoft Corporation, etc. In another embodiment, the sales interaction platform 104 is configured as a server cluster that is maintained at a fixed location. In an embodiment as exemplarily illustrated in FIG. 1, the sales interaction platform 104 comprises at least one processor 105, a memory unit 109 operably and communicatively coupled to the processor(s) 105, one or more databases, for example, 111, 112, 116, 119, 120, 121, etc., and one or more modules 110, 113, 114, 115, 117, and 118 defining computer program instructions executable by the processor(s) 105 for executing a live interaction between a customer at a customer location and a sales entity at a physical location of a retailer in real time to facilitate sales in a virtual environment. The memory unit 109 is a non-transitory, computer-readable storage medium configured to store the computer program instructions executable by the processor(s) 105. In an embodiment, the databases comprise a customer database 111, a sales entity database 112, and an interaction database 116 as exemplarily illustrated in FIG. 1. The customer database 111 is configured to store customer information of the customers. The customer information comprises, for example, a unique customer identifier assigned to the customer and/or the customer application 102 deployed on each of the customer devices 101a, 101b, 101z, etc. The sales entity database 112 is configured to store sales entity information of the sales entities. The sales entity information comprises, for example, a unique sales identifier assigned to each of the sales entities employed by the retailer. The interaction database 116 is configured to store information on the live interaction between the sales entities and the customers. In another embodiment, the databases further comprise a product database 119, a device database 120, and a coupon database 121. The product database 119 is configured to store information of all the products and other merchandised items provided and managed by the retailer. The device database 120 is configured to store sales device information of the sales devices 123a, 123b, 123z, etc. The sales device information comprises, for example, a unique device identifier assigned to each of the sales devices 123a, 123b, 123z, etc., or to the sales application 124 deployed on each of the sales devices 123a, 123b, 123z, etc., device specifications, etc. The coupon database 121 is configured to store information of promotional coupons issued by the sales entities to the customers.

Each of the databases 111, 112, 116, 119, 120, and 121 is a storage area or a storage medium configured to be used for storing data and files. Each of the databases 111, 112, 116, 119, 120, and 121 can be, for example, any of a structured query language (SQL) data store or a not only SQL (NoSQL) data store such as the Microsoft® SQL Server®, the Oracle® servers, the MySQL® database of MySQL AB Limited Company, the mongoDB® of MongoDB, Inc., the Neo4j graph database of Neo Technology Corporation, the Cassandra database of the Apache Software Foundation, the HBase® database of the Apache Software Foundation, etc. In an embodiment, each of the databases 111, 112, 116, 119, 120, and 121 can also be a location on a file system. In another embodiment, each of the databases 111, 112, 116, 119, 120, and 121 can be remotely accessed by the sales interaction platform 104 via the network 125. In another embodiment, each of the databases 111, 112, 116, 119, 120, and 121 is configured as a cloud-based database implemented in a cloud computing environment.

The memory unit 109 is a storage unit used for recording, storing, and reproducing data, program instructions, and applications. In an embodiment, the memory unit 109 comprises a random-access memory (RAM) or another type of dynamic storage device that serves as a read and write internal memory and provides short-term or temporary storage for information and instructions executable by the processor(s) 105. The memory unit 109 also stores temporary variables and other intermediate information used during execution of the instructions by the processor(s) 105. In another embodiment, the memory unit 109 further comprises a read-only memory (ROM) or another type of static storage device that stores firmware, static information, and instructions for execution by the processor(s) 105. In an embodiment, the modules, for example, 110, 113, 114, 115, 117, and 118 and the databases 111, 112, 116, 119, 120, and 121 of the sales interaction platform 104 are stored in the memory unit 109. For purposes of illustration, the modules, for example, 110, 113, 114, 115, 117, and 118 and the databases 111, 112, 116, 119, 120, and 121 of the sales interaction platform 104 are exemplarily shown to be a part of an in-memory system of the sales interaction platform 104; however, the scope of the system 100 disclosed herein is not limited to the modules 110, 113, 114, 115, 117, and 118 and the databases 111, 112, 116, 119, 120, and 121 being part of an in-memory system, but extends to the modules 110, 113, 114, 115, 117, and 118 and the databases 111, 112, 116, 119, 120, and 121 being distributed across a cluster of multiple computer systems (not shown), for example, computers, servers, virtual machines, containers, nodes, etc., coupled to the network 125, where the computer systems operate as a team and coherently communicate and coordinate with each other to share resources, distribute workload, and execute different portions of the logic to execute a live interaction between a customer at a customer location and a sales entity at a physical location of a retailer in real time to facilitate sales in a virtual environment. Each computer system in the cluster executes a part of the logic, and coordinates with other computer systems in the cluster to provide the complete functionality of the system 100 and the method disclosed herein.

The processor(s) 105 is configured to execute the modules, for example, 110, 113, 114, 115, 117, and 118 of the sales interaction platform 104 for executing a live interaction between a customer at a customer location and a sales entity at a physical location of a retailer in real time to facilitate sales in a virtual environment. The modules, for example, 110, 113, 114, 115, 117, and 118 of the sales interaction platform 104, when loaded into the memory unit 109 and executed by the processor(s) 105, transform the sales interaction platform 104 into a specially-programmed, special purpose computing device configured to implement the functionality disclosed herein. The processor(s) 105 refers to one or more microprocessors, central processing unit (CPU) devices, finite state machines, computers, microcontrollers, digital signal processors, logic, logic devices, application-specific integrated circuits (ASICs), field-programmable gate arrays (FPGAs), chips, etc., or any combination thereof, capable of executing computer programs or a series of commands, instructions, or state transitions. In an embodiment, the processor(s) 105 is implemented as a processor set comprising, for example, a programmed microprocessor and a math or graphics co-processor. The sales interaction platform 104 is not limited to employing the processor(s) 105. In an embodiment, the sales interaction platform 104 employs a controller or a microcontroller.

As exemplarily illustrated in FIG. 1, the sales interaction platform 104 further comprises a data bus 122, a display unit 106, a network interface 107, and common modules 108 of a computer system. The data bus 122 permits communications and exchange of data between the components, for example, 105, 106, 107, 108, and 109 of the sales interaction platform 104. The data bus 122 transfers data to and from the memory unit 109 and into or out of the processor(s) 105. The display unit 106, via a user interface, for example, a graphical user interface (GUI) 106a, displays user interface elements such as input fields for allowing a user, for example, an operator of the sales interaction platform 104 to input data into the sales interaction platform 104. The GUI 106a comprises, for example, any one of an online web interface, a web-based downloadable application interface, a mobile-based downloadable application interface, etc. In an embodiment, the GUI 106a is a user interface, for example, a webpage, rendered by the retailer in the virtual environment. In this embodiment, the GUI 106a displays a list of merchandised items offered by the retailer to the customers.

The network interface 107 is configured to connect the sales interaction platform 104 to the networks 103 and 125. In an embodiment, the network interface 107 is provided as an interface card also referred to as a line card. The network interface 107 is, for example, one or more of infrared interfaces, interfaces implementing Wi-Fi® of Wi-Fi Alliance Corporation, universal serial bus (USB) interfaces, Ethernet interfaces, frame relay interfaces, cable interfaces, digital subscriber line interfaces, token ring interfaces, peripheral component interconnect (PCI) interfaces, local area network (LAN) interfaces, wide area network (WAN) interfaces, interfaces using serial protocols, interfaces using parallel protocols, asynchronous transfer mode interfaces, fiber distributed data interfaces (FDDI), interfaces based on transmission control protocol (TCP)/internet protocol (IP), interfaces based on wireless communications technology such as satellite technology, radio frequency technology, near field communication, etc. The common modules 108 of the sales interaction platform 104 comprise, for example, input/output (I/O) controllers, input devices, output devices, fixed media drives such as hard drives, removable media drives for receiving removable media, etc. The output devices output the results of operations performed by the modules, for example, 110, 113, 114, 115, 117, and 118 of the sales interaction platform 104. Computer applications and programs are used for operating the sales interaction platform 104. The programs are loaded onto fixed media drives and into the memory unit 109 via the removable media drives. In an embodiment, the computer applications and programs are loaded into the memory unit 109 directly via the network 125.

The modules 110, 113, 114, 115, 117, and 118 of the sales interaction platform 104 are deployed and implemented in the sales interaction platform 104 using programmed and purposeful hardware as exemplarily illustrated in FIG. 1. In an embodiment, the modules 110, 113, 114, 115, 117, and 118 of the sales interaction platform 104 are computer-embeddable systems that execute a live interaction between a customer at a customer location and a sales entity at a physical location of a retailer in real time to facilitate sales in a virtual environment. In an exemplary implementation illustrated in FIG. 1, the modules of the sales interaction platform 104 comprise a data reception module 110, a matching module 113, an interactive media conferencing module 114, and an interactive sales activity module 115. The data reception module 110 receives a request for communication from one of the customer devices, for example, 101a, associated with one of the customers at the customer location, via the network 103. In an embodiment, there may be a single customer at the customer location. In another embodiment, there may be two or more customers, for example, family, friends, etc., of the customer at the same customer location. In an embodiment, the data reception module 110 receives a user action on a user interface rendered by the retailer in the virtual environment, as the request for communication. In an embodiment, the user interface is a web interface rendered by a website of the retailer. In another embodiment, the user interface is a mobile interface rendered by a mobile application of the retailer. The customer may be unknown and unidentified by the sales interaction platform 104 at the time the request for communication is made. In an embodiment, the data reception module 110 utilizes the unique customer identifier of the customer, who is known and identified by the sales interaction platform 104, to store the customer information in the customer database 111. In another embodiment, the data reception module 110 utilizes a temporary identifier, for example, a unique session identifier assigned to a particular bidirectional, interactive media conferencing session with the customer, to store the customer information in the customer database 111. The interactive media conferencing module 114 assigns the unique session identifier to a particular bidirectional, interactive media conferencing session with the customer based on minimal information about the customer, for example, the customer's network location that approximates a physical location of the customer, determined by the data reception module 110.

In an embodiment, the matching module 113 matches the customer at the customer location with one of the sales entities at the physical location of the retailer by executing one or more matching algorithms. In an embodiment where the customer logs into the sales interaction platform 104 via a user interface, for example, a web interface of a website associated with the retailer, using the customer application 102 or another browser or mobile application, and identifies themselves, the matching module 113 communicates with the customer database 111 and the sales entity database 112 to retrieve the unique customer identifier assigned to the customer and the unique sales identifiers assigned to the sales entities to execute the matching process. In another embodiment where the customer is unknown and unidentified similar to when the customer walks into the physical location of the retailer and interacts with a sales entity who is unaware of the customer's identity, the matching module 113 executes the matching process using minimal information about the customer, for example, location information derived from the customer's network location and/or a lookup that provides the customer's approximate location. In this embodiment, the matching module 113 assigns a temporary identifier to the unidentified customer for matching the customer to a sales entity and in turn for creating a unique communication channel between the customer and the sales entity.

In an embodiment, the matching algorithm(s) is a computer algorithm(s) configured to define criteria comprising, for example, availability criteria of the sales entities and suitability criteria of the sales entities, based on which the matching is performed. In an embodiment, the matching module 113 determines availability of a sales entity by checking whether the sales entity has logged into the sales application 124 deployed on the sales device, for example, 123a, associated with the sales entity, and connected to the sales interaction platform 104 via the network 125. In another embodiment, the sales interaction platform 104 maintains a facility in the sales entity database 112 by which a sales entity is marked as “available” or “not available” based on their actual availability. The sales interaction platform 104 marks each sales entity as “available” as soon as they authenticate themselves to their respective sales devices 123a, 123b, 123z, etc. The sales interaction platform 104 marks each sales entity as “not available” when the sales entity exits the sales application 124 at the end of their day or shift.

The suitability criteria comprises, for example, one or more of domains of expertise of the sales entities, the physical location of the retailer, the customer location, geographical location of the sales entities, interaction history, proximity of the sales entities to the customer location determined using global positioning system (GPS) data, department of a merchandised item of interest derived from a unique item identifier, the customer information, demographic information, historical information of previous bidirectional, interactive media conferencing sessions conducted between the customer and a corresponding one of the sales entities, preferences of the customers and the sales entities, etc. The historical information of the previous bidirectional, interactive media conferencing sessions comprises, for example, number and/or length of the previous bidirectional, interactive media conferencing sessions. The historical information of the previous bidirectional, interactive media conferencing sessions is stored in the interaction database 116. In an embodiment, the suitability criteria comprise two or more of the above listed criteria. In an embodiment, the matching module 113 communicates with the interaction database 116 to retrieve the historical information of the previous bidirectional, interactive media conferencing sessions conducted between the customer and a corresponding one of the sales entities and execute the matching process using the historical information of the previous bidirectional, interactive media conferencing sessions. In another embodiment, the matching module 113 matches the customer at the customer location with one of the sales entities at the physical location of the retailer by executing one or more machine learning algorithms, deep learning algorithms, and other artificial intelligence (AI) and non-AI algorithms.

Consider an example where a customer requests for assistance on a merchandised item, for example, a product such as a television set, displayed on a webpage of a website of a retailer. The matching module 113 executes a matching algorithm that defines criteria for matching the customer at the customer location with one of multiple sales entities, for example, sales agents, at the physical location of the retailer as follows. The matching module 113 uses criteria, for example, the customer's approximate network location extracted from the customer's public internet protocol (IP) address, to determine that the customer is located in Cupertino, California, USA. The matching module 113 sorts through a list of physical retail store locations of the retailer and determines that a retail store in Sunnyvale, California, USA is the closest store with respect to the customer's location, and a retail store in Mountain View, California, USA is the next closest store with respect to the customer's location. The matching module 113 also uses other criteria, for example, department of the product, defined by the matching algorithm for executing the matching process. In this example, the matching module 113 determines that the product on which the customer requested for assistance, falls in the “Electronics/TV” department. Of all the sales agents located in the department of the product in which the customer is interested, the matching module 113 identifies that there are no available sales agents in Sunnyvale, but there are two sales agents that are free and available immediately at Mountain View. In an exemplary implementation, the matching module 113 randomly selects one of the two available sales agents in Mountain View, and connects these sale agents to the requesting customer.

Consider another example where a customer logs into a website of the retailer, and requests for assistance on a particular product, after authentication by the sales interaction platform 104. The data reception module 110 receives the request, which contains not only the customer's approximate physical location based upon the customer's public internet protocol (IP) address, but also the customer's identity received via the login and authentication of the customer before the customer requested for assistance. The matching module 113, in communication with the data reception module 110, determines that the physically identified approximate location of the customer is Cupertino, California, USA, based on the customer's public IP address. The matching module 113 also determines that two physical retail stores closest to the customer's current location, are in Sunnyvale, California, USA, and Mountain View, California, USA. From the product that the customer selected, the matching module 113 determines that the department is “Electronics/TV”, and that there are two sales entities, for example, sales persons, ready and available at Sunnyvale, and 1 sales person ready and available at Mountain View. From the identity of the customer, and based upon their past history of interaction, the matching module 113 also determines that the customer has already spoken to one of the sales persons at Sunnyvale at least three times before, and has provided good reviews of their interaction with that sales person. The matching module 113 also determines that this sales person is one of the sales persons that are ready and available at the current time. The matching module 113 therefore connects the customer with the available sales person.

The interactive media conferencing module 114 establishes a bidirectional, interactive media conferencing session between the customer device, for example, 101a, at the customer location and one of the sales devices, for example, 123a, associated with the matched sales entity at the physical location of the retailer via the respective networks 103 and 125. As used herein, the term “bidirectional, interactive media conferencing session” refers to a two-way or multipoint reception and transmission of media signals, for example, video signals and/or audio signals, between a customer at the customer location and the matched sales entity at the physical location of the retailer for communication in real time. The bidirectional, interactive media conferencing session comprises an online meeting where the customer and the matched sales entity engage in a live audio-visual call, thereby simulating a face-to-face meeting. The bidirectional, interactive media conferencing session is, for example, one of an interactive video conferencing session, an interactive audioconferencing session, an interactive audio-visual conferencing session, an interactive visual conferencing session with a textual translation of audio content, and an interactive multimedia conferencing session. The interactive video conferencing session is a two-way or multipoint reception and transmission of video signals between a customer at the customer location and the matched sales entity at the physical location of the retailer, thereby allowing the customer and the matched sales entity to see and communicate with each other. The interactive audioconferencing session is a two-way or multipoint reception and transmission of audio signals between a customer, for example, a customer who is visually impaired or blind, at the customer location, and the matched sales entity at the physical location of the retailer, thereby allowing the customer and the matched sales entity to hear and communicate with each other through voice.

The interactive audio-visual conferencing session is a two-way or multipoint reception and transmission of video signals and audio signals between a customer at the customer location and the matched sales entity at the physical location of the retailer, thereby allowing the customer and the matched sales entity to see, hear, and communicate with each other through voice, gestures, etc. The interactive visual conferencing session with a textual translation of audio content is a two-way or multipoint reception and transmission of video signals between a customer, for example, a customer who is aurally impaired or deaf, at the customer location, and the matched sales entity at the physical location of the retailer, where the audio content is translated into text and overlayed at a predefined area of an application interface, thereby allowing the customer and the matched sales entity to see and communicate with each other through gestures, sign language, text, etc. The interactive multimedia conferencing session is a two-way or multipoint reception and transmission of multimedia signals, for example, video signals, audio signals, etc., and textual content between a customer at the customer location and the matched sales entity at the physical location of the retailer, thereby allowing the customer and the matched sales entity to see, hear, and communicate with each other through voice, gestures, sign language, text, etc.

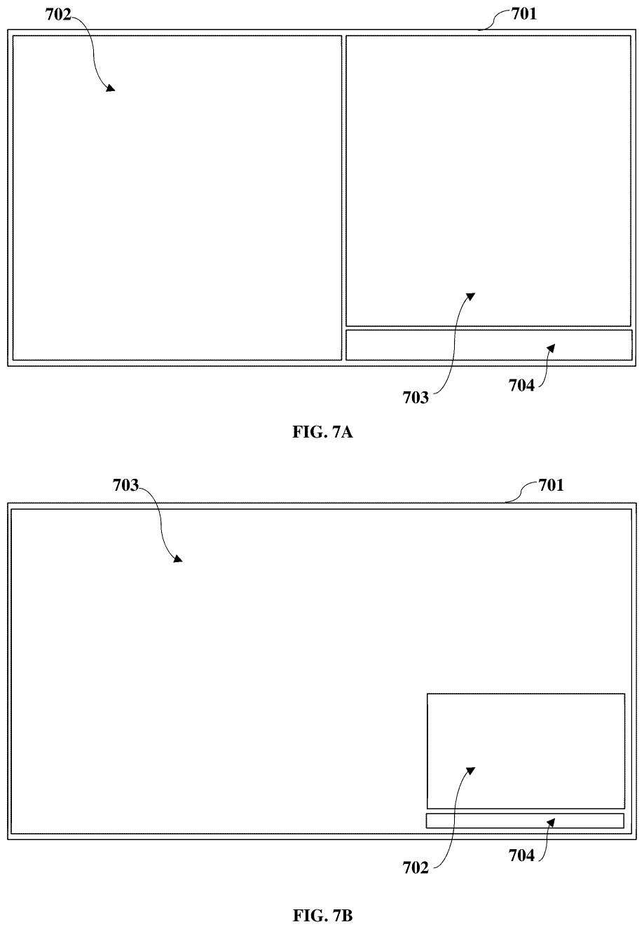

The interactive media conferencing module 114 establishes the bidirectional, interactive media conferencing session via an electronic media link between the customer application 102 on the customer device 101a and the sales application 124 on the sales device 123a of the matched sales entity for bidirectional interactivity therebetween. The electronic media link is, for example, an interactive audio-video link between the customer application 102 or another browser or mobile application on the customer device 101a and the sales application 124 on the sales device 123a that connects the customer and the matched sales entity and allows a bidirectional interactivity that mirrors a real-world visit to a physical location of the retailer, for example, a physical store of the retailer. In an embodiment, the interactive media conferencing module 114 establishes the bidirectional, interactive media conferencing session using Voice over Internet Protocol (VoIP) technology where voice communications and multimedia content are transmitted over internet protocol (IP) networks, for example, the internet. The VoIP technology converts analog video signals captured, for example, by a camera, and audio signals captured, for example, by a microphone, into data packets configured to be transmitted over the internet. On reaching the destination, the data packets are converted back into analog video signals and audio signals for attendees of the bidirectional, interactive media conferencing session to see and hear. In an embodiment, the interactive media conferencing module 114 establishes a secure, bidirectional, interactive media conferencing session between the customer device 101a at the customer location and the sales device 123a of the matched sales entity at the physical location of the retailer via the respective networks 103 and 125. In an embodiment, the bidirectional, interactive media conferencing session is secured using various encryption techniques, for example, public key cryptography that operates with public-private key pairs to maintain secure end-to-end privacy and confidentiality. In another embodiment where the customer's identity is known, the bidirectional, interactive media conferencing session is secured, for example, using authentication credentials. In an embodiment, when the bidirectional, interactive media conferencing session is established via the electronic media link between the customer application 102 on the customer device 101a and the sales application 124 deployed on the sales device 123a, the interactive media conferencing module 114 launches an application interface 701 on the customer device 101a and the sales device 123a as exemplarily illustrated in FIGS. 7A-7B and as disclosed in the description of FIGS. 7A-7B.

In an embodiment, the interactive media conferencing module 114 renders an interface element, for example, an icon, a link, a text, an input element such as a menu selector, etc., associated with each of multiple merchandised items managed by the retailer on the user interface, for example, a webpage of a website, rendered by the retailer in the virtual environment. On receiving a user action on the interface element associated with any of the merchandised items displayed on the user interface, the interactive media conferencing module 114 establishes the bidirectional, interactive media conferencing session associated with that merchandised item between the customer device 101a at the customer location and the sales device 123a at the physical location of the retailer via the respective networks 103 and 125. In an example, the interactive media conferencing module 114 displays each product on a webpage with an associated icon, on which customers may perform a user action, for example, a click associated with the particular product on the webpage, in order to be connected to a sales entity, for example, a sales person, a sales associate, etc., at the physical location of the retailer. Clicking on this icon activates a connection to the sales interaction platform 104, and requests a connection to a suitable sales entity. In an embodiment, the interactive media conferencing module 114 utilizes the unique customer identifier to connect to the identified customer at any time. In another embodiment where the customer is unidentified, the interactive media conferencing module 114 cannot connect to the customer at any time. The interactive media conferencing module 114 assigns a temporary identifier, for example, a unique session identifier, for the bidirectional, interactive media conferencing session with the unidentified customer, which does not persist until and unless the customer chooses, for example, to log into the website of the retailer and identify themselves. If the customer chooses not to identify themselves, then each individual interaction generates a new unique session identifier in the sales interaction platform 104. In an embodiment, the interactive media conferencing module 114 renders the interface element similar to a chat mechanism on the user interface rendered by the retailer, without the interface element being associated with a particular merchandised item. In this embodiment, clicking on the interface element initiates a generic, bidirectional, interactive media conferencing session about any aspect of sales.

In an embodiment, the matching module 113 identifies a department at the physical location of the retailer where the selected or clicked merchandised item is stored, using a unique item identifier assigned to the merchandised item. On determining the department where the merchandised item is stored, the matching module 113 performs a lookup in the sales entity database 112 to determine sales entities associated with the identified department. The matching module 113 then determines which sales entity in the department is available and suitable based on the above-disclosed criteria used for matching the customer to the sales entity. The matching module 113 also performs a lookup in the sales entity database 112 and the device database 120 to determine whether a matched sales entity is logged into the sales interaction platform 104 using the sales application 124 on one of the sales devices 123a, 123b, 123z, etc., and to determine which of the sales devices 123a, 123b, 123z, etc., is being used by the matched sales entity. On determining the sales device being used by the matched sales entity, the interactive media conferencing module 114 automatically launches the sales application 124 on the sales device, for example, 123a, for establishing a bidirectional, interactive media conferencing session between the customer device 101a at the customer location and the sales device 123a at the physical location of the retailer.

In an embodiment, on receiving the user action from the customer device 101a associated with the customer, the interactive media conferencing module 114 establishes the bidirectional, interactive media conferencing session between the customer device 101a at the customer location and the sales device 123a at the physical location of the retailer via the respective networks 103 and 125 as follows: The interactive media conferencing module 114 activates a connection from the customer application 102 on the customer device 101a to the sales interaction platform 104 via the network 103, using the unique customer identifier; the matching module 113 matches the customer identified by the unique customer identifier at the customer location with one of the sales entities at the physical location of the retailer based on the above-disclosed criteria defined by the matching algorithm(s); and the interactive media conferencing module 114, in communication with the matching module 113, then requests and establishes a connection to the sales application 124 on the sales device 123a of the matched sales entity at the physical location of the retailer via the network 125.

The interactive sales activity module 115 executes, through the bidirectional, interactive media conferencing session, one or more of multiple interactive sales activities substantially analogous to a physical interaction between the customers and the sales entities at the physical location of the retailer in real time. The interactive sales activities are configured to enhance the sales and aid decision-making of the customers. The interactive sales activities comprise rendering auxiliary information with metadata configured to be uniquely identified with a unique sales identifier of the matched sales entity, to the customer device 101a. In an embodiment, the metadata associated with the matched sales entity and rendered with the auxiliary information comprise, for example, expertise of the sales entity, physical location of the sales entity, department of the sales entity, etc. In an embodiment, the sales interaction platform 104 further comprises a training module 118 configured to utilize the metadata for identifying the matched sales entity, monitoring their interaction with the customer, recording their effectiveness with the customer, and training the matched sales entity. In an embodiment, the interactive sales activities further comprise a bidirectional question-answer session between the customer and the matched sales entity. In another embodiment, the interactive sales activities further comprise bidirectional communication and exchange of sales information related to merchandised items, promotions, offers, etc., of the retailer between the customer and the matched sales entity. In another embodiment, the interactive sales activities further comprise interactive viewing, by the customer, of the merchandised items managed by the retailer.

In another embodiment, the interactive sales activities further comprise customer engagement activities associated with the auxiliary information comprising one or more of promotional coupons, alternative product recommendations, product media, ratings, studies, online product research and discovery elements such as webpages, hyperlinks, and media content, etc., to engage the customer. In an embodiment, the promotional coupons are personalized coupons. As used herein, “personalized coupon” refers to a coupon that is generated for a specific merchandised item, for example, a product, in which the customer has expressed interest, that can be used only once, and that, therefore, cannot be widely broadcast on the internet and used by any other user, for a discount percentage, for example, about 13%, that the sales entity determines would provide a right price for the customer, in accordance with maximum discount guidelines for the product defined by the retailer. In an embodiment, the personalized coupons are time-limited coupons configured to expire at a date and/or a time defined by the sales entity in accordance with guidelines defined by the retailer. In an embodiment, the promotional coupons are configured to be used by the customer in the same bidirectional, interactive media conferencing session using the same customer device. In another embodiment, the promotional coupons are configured to be used by the customer in a different bidirectional, interactive media conferencing session using the same customer device. In another embodiment, the promotional coupons are configured to be used by the customer in the same bidirectional, interactive media conferencing session using a different customer device. In another embodiment, the promotional coupons are configured to be used by the customer in a different bidirectional, interactive media conferencing session using a different customer device. In another embodiment, the promotional coupons are configured to be used in any application or any shopping session, for example, an online shopping session, a physical shopping session, etc., associated with or separate from the bidirectional, interactive media conferencing session, and based on their uniqueness, are configured to be traced back to the previous bidirectional, interactive media conferencing session.

In an embodiment, the sales interaction platform 104 further comprises a tracking module 117 configured to track and link usage of the promotional coupons by the customer to the bidirectional, interactive media conferencing session using the metadata. At the point where the promotional coupon is issued, the customer may still be anonymous and unidentified. When the customer uses a unique promotional coupon to purchase a merchandised item, for example, a product, the tracking module 117 associates the promotional coupon along with metadata comprising all previous interactions, for example, all product recommendations made, etc., that led to provision of the promotional coupon and eventual purchase of the product, with the customer and the sale. The tracking module 117, in communication with the interaction database 116, the customer database 111, the sales entity database 112, and the coupon database 121, tracks and links back a future use of the time-limited promotional coupons by the customer, even in a completely different session or from a customer device different from the customer device used for the interaction with the sales entity, to the original interaction between the sales entity and the customer.

The interactive sales activity module 115, in communication with the interactive media conferencing module 114 and the tracking module 117, stores the information of the live interaction and the executed interactive sales activities in the interaction database 116. In an embodiment, the interactive sales activity module 115 utilizes the unique customer identifier to store the information of the live interaction between the customer and the matched sales entity in the interaction database 116. In an embodiment, the interactive sales activity module 115 utilizes the unique customer identifier to store personal, historical information of all the interactions, and any other available information about or from a specific customer in the customer database 111 and/or the interaction database 116. In another embodiment where the customer is unidentified, the interactive sales activity module 115 utilizes a temporary identifier, for example, a unique session identifier, assigned to the customer for a particular bidirectional, interactive media conferencing session, to store the information of the live interaction between the customer and the matched sales entity in the interaction database 116. In an embodiment, the interactive sales activity module 115 stores information of the live interaction against a unique bidirectional, interactive media conferencing session, which is associated with one or more unique promotional coupons that are issued during the unique bidirectional, interactive media conferencing session, in the interaction database 116. At the point at which the unique promotional coupon(s) is redeemed and the customer is identified by the unique customer identifier, the tracking module 117 utilizes the unique customer identifier to link back to the unique bidirectional, interactive media conferencing session, and to associate information of the unique bidirectional, interactive media conferencing session with the identified customer. In an embodiment, the tracking module 117 performs the linkage and association of the unique bidirectional, interactive media conferencing session with the identified customer post facto and substantially out of sequence with the initial unique bidirectional, interactive media conferencing session.

In an embodiment, the tracking module 117 identifies and tracks each of the sales entities through the unique sales identifier assigned thereto. The data reception module 110 utilizes the unique sales identifier to collect and store the sales entity information comprising geographical locations of each of the sales entities, one or more departments, one or more areas of expertise, and a complete history of interactions of each of the sales entities with the customers. The complete history of interactions comprises, for example, information about coupons, discounts, special offers, considerations that have been advanced to the customers by each of the sales entities, and associated customer redemption information. The data reception module 110 stores the sales entity information in the sales entity database 112. In an embodiment, the interactive sales activity module 115 utilizes the unique sales identifier to collect and store the complete history of interactions with the customers in the interaction database 116.

In another embodiment, the tracking module 117 identifies and tracks each of the sales devices 123a, 123b, 123z, etc., through the unique device identifier assigned thereto. In an embodiment, the interactive media conferencing module 114 utilizes the unique device identifier to check whether each of the sales devices 123a, 123b, 123z, etc., is connected to the sales interaction platform 104. The interactive media conferencing module 114 utilizes the unique device identifier for contacting each of the sales devices 123a, 123b, 123z, etc., at any time. In an embodiment, the tracking module 117 determines which sales device is being used by each sales entity by performing a lookup in the sales entity database 112 and/or the device database 120 based on the login performed by the sales entity through the sales application 124 on the sales device 123a. On determining the sales device 123a being used by the matched sales entity, the interactive media conferencing module 114 automatically launches the sales application 124 on the sales device 123a for establishing a bidirectional, interactive media conferencing session between the customer device 101a at the customer location and the sales device 123a. The interactive sales activity module 115 then executes, through the bidirectional, interactive media conferencing session, one or more interactive sales activities substantially analogous to a physical interaction between the customer and a sales entity at the physical location of the retailer in real time.

In an embodiment, the tracking module 117, in communication with the interactive sales activity module 115, links the live interaction conducted by the sales entity with a customer with a subsequent sale, even if the subsequent sale is performed without any further involvement from the sales entity, or if the subsequent sale is performed in a different shopping session. At the point where the customer initially requests information, the customer may be unknown and unidentified by the sales interaction platform 104. In an embodiment, the interactive media conferencing module 114 records the entire bidirectional, interactive media conferencing session between the customer and the matched sales entity. The tracking module 117, in communication with the interactive media conferencing module 114 and the interactive sales activity module 115, associates the recorded bidirectional, interactive media conferencing session with one or more unique promotional coupons that are issued by the sales entity to the customer and stores the association in the interaction database 116. At the point where the unique promotional coupon(s) is redeemed and the identity of the customer has become known, the tracking module 117 associates the unique customer identifier defining the customer's identity with the previous bidirectional, interactive media conferencing session and interaction. Information of these bidirectional, interactive media conferencing sessions that are associated with the identified customer, is configured to be used in future sessions if the customer chooses to identify themselves before the customer requests for assistance.

In an embodiment, the interactive media conferencing module 114 allows the matched sales entity to add another one or more of the sales entities to the bidirectional, interactive media conferencing session to assist the matched sales entity; and/or provide expertise of the other one or more sales entities in the live interaction with the customer. In an embodiment, the interactive media conferencing module 114 allows the matched sales entity to transition the bidirectional, interactive media conferencing session to the added sales entities. In another embodiment, the interactive media conferencing module 114 allows the customer to add another one or more customers to the bidirectional, interactive media conferencing session to allow the matched sales entity to interact with multiple customers simultaneously and then through the interactive sales activity module 115, execute one or more of the interactive sales activities identically across the multiple customers.

In an embodiment, the training module 118 of the sales interaction platform 104 is configured to determines effectiveness of the sales entities for training the sales entities, enhancing the effectiveness of the sales entities in communicating with the customers, and tracking continued improvement of the sales entities. The training module 118, in communication with the interactive media conferencing module 114 and the interactive sales activity module 115, collects metrics, for example: amount of time spent with a customer, before the sales entity issues a promotional coupon; the number of product recommendations made by the sales entity before the sales entity issues a promotional coupon; the amount of time spent between each product recommendation; the number of promotional coupons issued by the sales entity; the number or percentage of the promotional coupons redeemed by the customer; the rate at which the promotional coupons issued by the sales entity are redeemed by the customer, which may be viewed as a proxy for the effectiveness of the interaction with the customer; the number of times a back camera is activated to show the customer a merchandised item on a store shelf or another recommended merchandised item; etc. The training module 118 utilizes one or any combination of the collected metrics to gauge the effectiveness of the sales entities. In an embodiment, the training module 118 collects metrics as defined and customized by each retailer for determining effectiveness of their respective sales entities.

In another exemplary implementation of the system 100 disclosed herein, the system 100 comprises one or more customer systems 101, multiple sales entity systems 123, and the sales interaction platform 104 configured as a server. In an embodiment, where the customers are known and identified by the sales interaction platform 104, the customer system(s) 101 sends a request for communication and one or more unique customer identifiers to the sales interaction platform 104. Each of the sales entity systems 123 sends a unique device identifier, a unique sales identifier, and an availability identifier to the sales interaction platform 104. In this exemplary implementation, the sales interaction platform 104 comprises the customer database 111, the sales entity database 112, the interaction database 116, the matching module 113, and the interactive media conferencing module 114 configured, for example, as an interactive video unit. The customer database 111 comprises the unique customer identifiers of all identified customers and metadata representing one or more attributes of each of the customer. The sales entity database 112 comprises unique sales identifiers of the sales entities, unique device identifiers of the sales devices, and metadata representing one or more attributes of each of the sales entities. The metadata of each of the sales entities comprise, for example, availability, expertise of the sales entity, physical location of the sales entity, etc. The interaction database 116 comprises communication details of the live interactions between the customers and the sales entities. The matching module 113 matches a customer with one or more sales entities based on the metadata within the customer database 111 and the sales entity database 112. In an embodiment, the matching module 113 determines a proximity of the customer to the sales entity using global positioning system (GPS) locations. In an embodiment, the matching module 113 determines the number of prior interactions between the customer and a respective sales entity based on a number of bidirectional, interactive media conferencing sessions between the customer and the respective sales entity recorded in the interaction database 116. In another embodiment, the matching module 113 determines the number of prior interactions between the customer and the respective sales entity based on length of interactions between the customer and respective sales entity recorded in the interaction database 116. The interactive media conferencing module 114 initiates an interactive video communication between the customer and one or more of the matched sales entities. In an embodiment, for example, when a promotional coupon issued by the matched sales entity is redeemed by the customer, the tracking module 117 links the customer to the matched sales entity based on the metadata within the customer database 111 and the sales entity database 112, as the metadata may not be available at the time that the request for communication is initiated by the customer.

In the sales interaction platform 104, the processor(s) 105 retrieves the computer program instructions defined by the data reception module 110, the matching module 113, the interactive media conferencing module 114, the interactive sales activity module 115, the tracking module 117, and the training module 118 from the memory unit 109 for executing the respective functions disclosed above. The modules 110, 113, 114, 115, 117, and 118 of the sales interaction platform 104 are disclosed above as software executed by the processor(s) 105. In an embodiment, the modules 110, 113, 114, 115, 117, and 118 of the sales interaction platform 104 are implemented completely in hardware. In another embodiment, the modules 110, 113, 114, 115, 117, and 118 of the sales interaction platform 104 are implemented by logic circuits to carry out their respective functions disclosed above. In another embodiment, the sales interaction platform 104 is also implemented as a combination of hardware and software including one or more processors, for example, 105, that are used to implement the modules, for example, 110, 113, 114, 115, 117, and 118 of the sales interaction platform 104.

For purposes of illustration, the disclosure herein refers to the modules 110, 113, 114, 115, 117, and 118 of the sales interaction platform 104 being run locally on a single sales interaction platform 104; however the scope of the system 100 and the computer-implemented method disclosed herein is not limited to the modules 110, 113, 114, 115, 117, and 118 being run locally on a single sales interaction platform 104 via an operating system and the processor(s) 105, but extends to running the modules 110, 113, 114, 115, 117, and 118 remotely over the network 125 by employing a web browser, one or more remote servers, computers, mobile phones, and/or other electronic devices. In an embodiment, one or more modules, databases, processing elements, memory elements, storage elements, etc., of the system 100 disclosed herein are distributed across a cluster of computer systems (not shown), for example, computers, servers, virtual machines, containers, nodes, etc., coupled to the network 125, where the computer systems coherently communicate and coordinate with each other to share resources, distribute workload, and execute different portions of the logic to execute a live interaction between a customer at a customer location and a sales entity at a physical location of a retailer in real time to facilitate sales in a virtual environment.

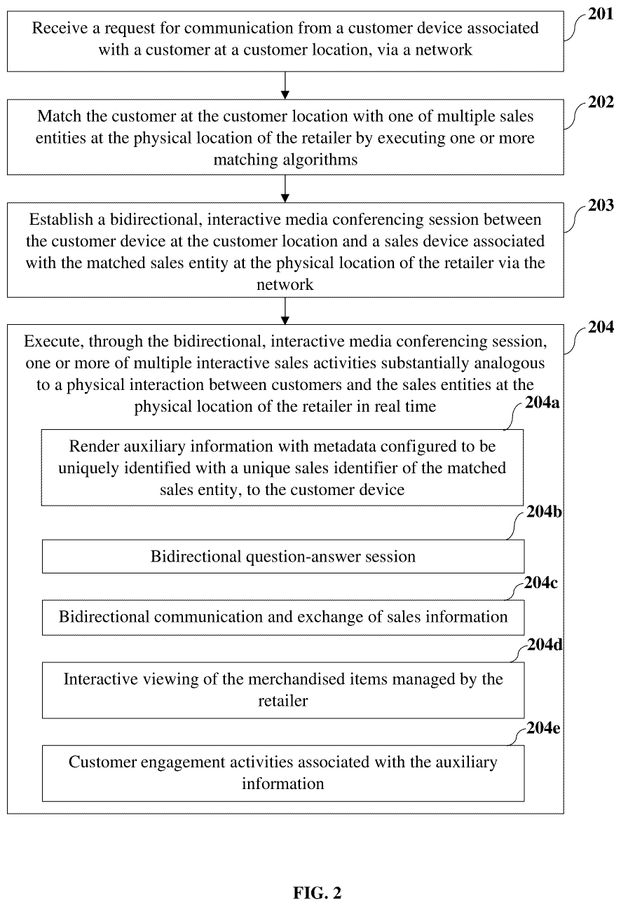

Disclosed herein is also a non-transitory, computer-readable storage medium configured to store computer program instructions executable by the processor(s) 105 for executing a live interaction between a customer at a customer location and a sales entity at a physical location of a retailer in real time to facilitate sales in a virtual environment. As used herein, “non-transitory, computer-readable storage medium” refers to all computer-readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The computer program instructions implement the processes of various embodiments disclosed above and perform additional steps that may be required and contemplated for executing a live interaction between a customer at a customer location and a sales entity at a physical location of a retailer in real time to facilitate sales in a virtual environment. When the computer program instructions are executed by the processor(s) 105, the computer program instructions cause the processor(s) 105 to perform the steps of the computer-implemented method for executing a live interaction between a customer at a customer location and a sales entity at a physical location of a retailer in real time to facilitate sales in a virtual environment as disclosed in the descriptions of FIGS. 1-2. In an embodiment, a single piece of computer program code comprising computer program instructions performs one or more steps of the computer-implemented method disclosed in the descriptions of FIGS. 1-2. The processor(s) 105 retrieves these computer program instructions and executes them.

A module, or an engine, or a unit, as used herein, refers to any combination of hardware, software, and/or firmware. As an example, a module, or an engine, or a unit includes hardware such as a microcontroller, associated with a non-transitory, computer-readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented in any programming language, for example, C, C++, C #, Java®, JavaScript®, Fortran, Ruby, Perl®, Python®, Visual Basic®, hypertext preprocessor (PHP), Microsoft °.NET, ObjectiveC®, etc., for performing one or more steps of the computer-implemented method disclosed in the descriptions of FIGS. 1-2. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

FIG. 2 illustrates a flowchart of an embodiment of a computer-implemented method for executing a live interaction between a customer at a customer location and a sales entity at a physical location of a retailer in real time to facilitate sales in a virtual environment. The computer-implemented method disclosed herein employs the sales interaction platform for executing a live interaction between a customer at a customer location and a sales entity at a physical location, for example, a retail location or a display location, of a retailer in real time to facilitate sales in a virtual environment. The sales interaction platform is communicatively coupled to multiple sales devices associated with sales entities and to multiple customer devices associated with customers, via a network, for example, the internet. In the computer-implemented method disclosed herein, the sales interaction platform receives 201 a request for communication from one of the customer devices associated with one of the customers at the customer location, via the network. In an embodiment, the sales interaction platform receives a user action on a user interface rendered by the retailer in the virtual environment, as the request for communication. The sales interaction platform matches 202 the customer at the customer location with one of the sales entities at the physical location of the retailer by executing one or more matching algorithms comprising, for example, machine learning algorithms, deep learning algorithms, and other artificial intelligence (AI) and non-AI algorithms as disclosed in the description of FIG. 1.

The sales interaction platform establishes 203 a bidirectional, interactive media conferencing session between the customer device at the customer location and one of the sales devices associated with the matched sales entity at the physical location of the retailer via the network. The bidirectional, interactive media conferencing session is, for example, one of an interactive video conferencing session, an interactive audioconferencing session, an interactive audio-visual conferencing session, an interactive visual conferencing session with a textual translation of audio content, and an interactive multimedia conferencing session. The sales interaction platform executes 204, through the bidirectional, interactive media conferencing session, one or more of multiple interactive sales activities substantially analogous to a physical interaction between the customers and the sales entities at the physical location of the retailer in real time. The interactive sales activities are configured to enhance the sales and aid decision-making of the customers. The interactive sales activities comprise rendering 204a auxiliary information with metadata configured to be uniquely identified with a unique sales identifier of the matched sales entity, to the customer device. In an embodiment, the interactive sales activities further comprise a bidirectional question-answer session 204b between the customer and the matched sales entity. In another embodiment, the interactive sales activities further comprise bidirectional communication and exchange of sales information 204c related to merchandised items, promotions, offers, etc., of the retailer between the customer and the matched sales entity. In another embodiment, the interactive sales activities further comprise interactive viewing 204d, by the customer, of the merchandised items managed by the retailer. In another embodiment, the interactive sales activities further comprise customer engagement activities 204e associated with the auxiliary information comprising one or more of promotional coupons, alternative product recommendations, product media, ratings, studies, online product research and discovery elements such as webpages, hyperlinks, and media content, etc., to engage the customer. In an embodiment, the sales interaction platform tracks and links usage of the promotional coupons by the customer to the bidirectional, interactive media conferencing session using the metadata.

In an embodiment where a customer is identified, for example, after the bidirectional, interactive media conferencing session is concluded and when a promotional coupon that was issued during the bidirectional, interactive media conferencing session is redeemed, the sales interaction platform utilizes the unique customer identifier of the customer to: (a) connect to the identified customer at any time; and (b) store the customer information and the information of the live interaction between the customer and the matched sales entity. In an embodiment, the sales interaction platform utilizes the unique customer identifier to store personal, historical information of all interactions, and any other available information about or from a specific customer in the customer database and/or the interaction database. In an embodiment, the sales interaction platform identifies and tracks each of the sales entities through a unique sales identifier assigned thereto. The sales interaction platform utilizes the unique sales identifier to collect and store sales entity information comprising, for example, geographical locations of each of the sales entities, one or more departments, one or more areas of expertise, and a complete history of interactions of each of the sales entities with the customers as disclosed in the description of FIG. 1. In another embodiment, the sales interaction platform identifies and tracks each of the sales devices through a unique device identifier assigned thereto. The sales interaction platform utilizes the unique device identifier to check whether each of the sales devices is connected to the sales interaction platform. The sales interaction platform utilizes the unique device identifier for contacting each of the sales devices at any time.

Consider an example where a retailer hosts a retail store on an online shopping website and displays a list of merchandised items with associated interface elements, for example, icons, links, etc., for triggering a live interaction between a customer and a sales entity, on a webpage of the online shopping website. When the customer clicks on an icon or a link displayed along with a merchandised item on the webpage, which indicates that the customer may directly contact a sales entity for assistance, the customer application is invoked and opened on the customer device, that requests the sales interaction platform for an audio-visual link with the sales entity at a physical location in the retail store. On determining to which sales entity the customer may be connected, the sales interaction platform determines which sales device is being used by the sales entity. The sales interaction platform utilizes the information of the sales device being used by the sales entity to automatically launch the sales application deployed on the sales device. The customer application on the customer device and the sales application on the sales device are then connected to each other to establish a bidirectional, interactive media conferencing session. In an embodiment, the customer application and the sales application automatically activate a camera and a microphone on the customer device and the sales device, respectively, and forward information from the camera and the microphone between the customer device and the sales device, so that the customer and the sales entity may see and hear each other to communicate with each other. In an embodiment, the customer application on the customer device and the sales application on the sales device display the merchandised item on the webpage that the customer clicked on, to the customer and the sales entity, respectively, to provide context to the conversation therebetween. The sales interaction platform executes, through the bidirectional, interactive media conferencing session, one or more interactive sales activities substantially analogous to a physical interaction between the customers and the sales entity at the retail store in real time as disclosed in the description of FIG. 1.

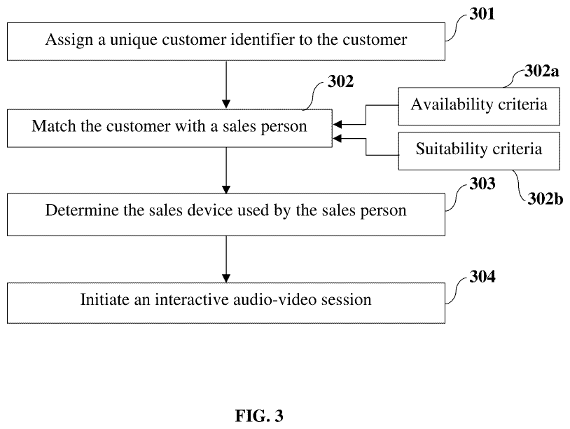

FIG. 3 exemplarily illustrates a flowchart of an embodiment of a method for matching a customer at a customer location with a sales entity at a physical location of a retailer and executing a bidirectional, interactive audio-video session therebetween in real time. Consider an example where a customer deploys the customer application on a customer device, for example, a smartphone. The sales interaction platform assigns 301 a unique customer identifier to the customer application and in turn, to the customer, to identify the customer to the sales interaction platform for a duration of the bidirectional, interactive audio-video session. The customer may view a list of merchandised items, for example, products, provided by the retailer on a user interface, for example, a webpage of a website, of the retailer. The sales interaction platform renders an icon adjacent to each of the merchandised items in the list on the webpage. When the customer clicks on the icon adjacent to a particular merchandised item, the sales interaction platform activates a connection from the customer application on the customer device to the sales interaction platform via the network, using the unique customer identifier. The sales interaction platform matches 302 the customer identified by the unique customer identifier at the customer location with one of the sales entities at the physical location of the retailer based on the criteria comprising availability criteria 302a and suitability criteria 302b comprising, for example, expertise of the sales entity, physical location of the sales entity, proximity of the sales entity to the customer location, interaction history, etc., as disclosed in the description of FIG. 1.

In an embodiment, the sales interaction platform utilizes a unique item identifier that defines the identity of the merchandised item that the customer clicked on to identify a department in the physical location of the retailer that holds the merchandised item in which the customer is interested. If the customer location is available, then the sales interaction platform utilizes the customer location, along with the department, and any other customer information available in the customer database, to find a suitable sales entity to match with the customer. In an embodiment, the sales interaction platform determines the suitability of the sales entity, in addition to their availability at the current time, by their department as derived from the unique item identifier, their further specialized domain of expertise, their physical geographical location, and potential proximity to the customer. In another embodiment, the sales interaction platform utilizes other criteria to provide the best match to the perceived needs of the customer, for example, based upon information available about the customer, including the history of their prior interactions.

Furthermore, the sales interaction platform determines 303 which sales device the matched sales entity is using. Based on the sales device of the matched sales entity, the sales interaction platform then requests and establishes a connection to the sales device of the matched sales entity at the physical location of the retailer via the network. On establishing the connection to the sales device, the sales interaction platform initiates 304 a bidirectional, interactive media conferencing session, for example, an interactive audio-video session, between the customer device at the customer location and the sales device at the physical location of the retailer via the network. Through the interactive audio-video session, the sales interaction platform executes one or more interactive sales activities substantially analogous to a physical interaction between the customer and the sales entity at the physical location of the retailer in real time as disclosed in the description of FIGS. 1-2.

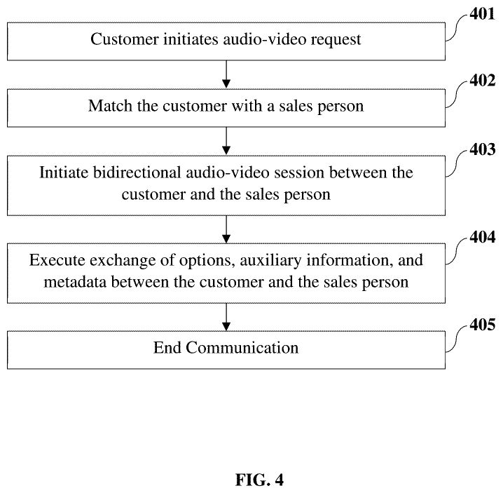

FIG. 4 exemplarily illustrates a flowchart of an embodiment of a method for executing a bidirectional, interactive audio-video session between a customer at a customer location and a sales entity, for example, a sales person, at a physical location of a retailer in real time to facilitate sales in a virtual environment. Consider an example where a customer initiates 401 an audio-video request, for example, by clicking an icon disposed adjacent to a merchandised item on a webpage of a retailer. Clicking on the icon activates a connection to the sales interaction platform and requests a connection to a suitable sales person. The sales interaction platform matches 402 the customer at the customer location with one of the sales persons at the physical location of the retailer based on criteria defined in one or more matching algorithms as disclosed in the description of FIG. 1. The sales interaction platform then requests and establishes a connection to a sales device associated with the matched sales person at the physical location of the retailer via the network. On establishing the connection to the sales device of the matched sales person, the sales interaction platform initiates 403 a bidirectional, interactive media conferencing session, for example, a bidirectional, interactive audio-video session, between the customer and the sales person. Through the bidirectional, interactive audio-video session, the sales interaction platform executes one or more interactive sales activities substantially analogous to a physical interaction between the customer and a sales person at the physical location of the retailer in real time. For example, the sales interaction platform executes 404 an exchange of options, auxiliary information, and metadata between the customer and the sales person. After completion of the exchange, the sales interaction platform ends 405 the communication between the customer and the sales person and stores information of the live interaction in the interaction database for future matching and bidirectional, interactive media conferencing sessions.

In an embodiment of the method for executing a bidirectional, interactive audio-video session between a customer at a customer location and a sales entity, for example, a sales representative, at a physical location of a retailer in real time to facilitate sales in a virtual environment, the sales interaction platform receives a request for communication from a customer through the customer application on the customer device. The request comprises a unique customer identifier configured to identify the customer for the duration of the bidirectional, interactive audio-video session. The sales interaction platform matches the customer with one or more sales representatives by executing one or more matching algorithms defining suitability criteria and availability criteria. The suitability criteria comprise, for example, two or more of expertise of the sales representative, geographical location of the sales representative, proximity of the customer to the sales representative, and number of prior interactions between the customer and the respective sales representative. The sales interaction platform determines the proximity of the customer to the sales representative using global positioning system (GPS) locations.

In an embodiment, the sales interaction platform determines the number of prior interactions between the customer and the respective sales representative based on the number of bidirectional, interactive audio-video sessions between the customer and respective sales representative. In another embodiment, when the identity of the customer is known or established, the sales interaction platform determines the number of prior interactions between the customer and the respective sales representative based on length of the interactions between the customer and respective sales representative. In an embodiment, the sales interaction platform determines which sales device is being used by the matched sales representative. On determining the sales device being used by the matched sales representative, the sales interaction platform automatically launches the sales application on the sales device for initiating the bidirectional, interactive audio-video session between the customer device at the customer location and the sales device at the physical location of the retailer. Through the bidirectional, interactive audio-video session, the sales representative sends auxiliary information and metadata to the customer. In an embodiment, the auxiliary information comprises a promotional coupon. In another embodiment, the sales interaction platform monitors the bidirectional, interactive audio-video session and determines effectiveness of the sales representative as disclosed in the description of FIG. 1.

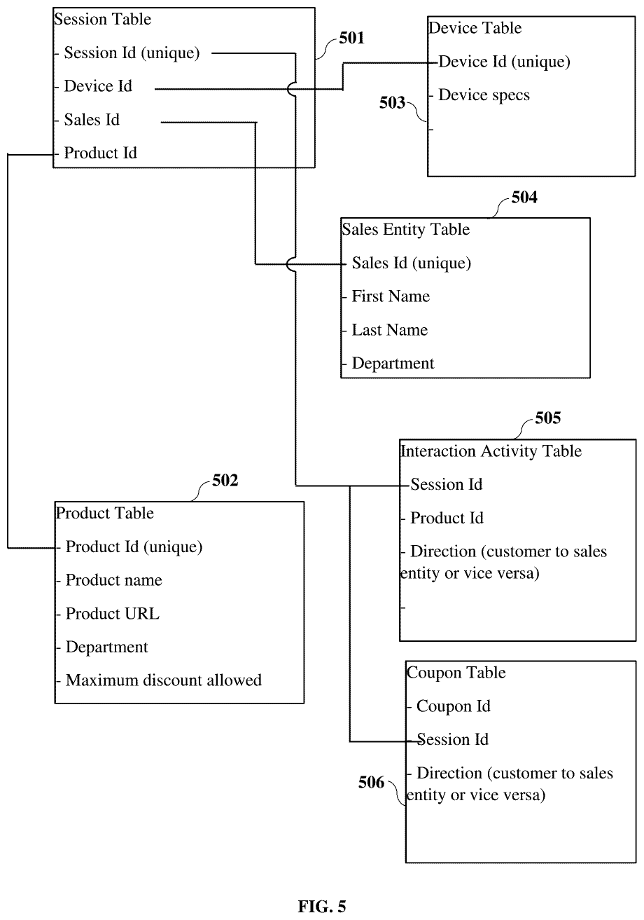

FIG. 5 exemplarily illustrates an embodiment of a database schema showing logical connections between different database tables implemented in the system 100 shown in FIG. 1, for executing a live interaction between a customer at a customer location and a sales entity at a physical location of a retailer in real time to facilitate sales in a virtual environment. In an embodiment as exemplarily illustrated in FIG. 5, the database tables comprise a session table 501, a product table 502, a device table 503, a sales entity table 504, an interaction activity table 505, and a coupon table 506. In an embodiment, the session table 501, the product table 502, the device table 503, the sales entity table 504, the interaction activity table 505, and the coupon table 506 are configured as parts of the databases of the sales interaction platform 104 exemplarily illustrated in FIG. 1. For example, the product table 502, the device table 503, the sales entity table 504, and the coupon table 506 are configured as parts of the product database 119, the device database 120, the sales entity database 112, and the coupon database 121, respectively, exemplarily illustrated in FIG. 1. The session table 501 and the interaction activity table 505 are configured as parts of the interaction database 116 exemplarily illustrated in FIG. 1.

When a bidirectional, interactive media conferencing session is established between a customer and a sales entity, the sales interaction platform 104 assigns a unique session identifier (Id) to the bidirectional, interactive media conferencing session and stores the unique session identifier in the session table 501 as exemplarily illustrated in FIG. 5. The session table 501 further stores a device identifier of the sales device used by the sales entity for participating in the bidirectional, interactive media conferencing session, a unique sales identifier of the sales entity engaged in the bidirectional, interactive media conferencing session, and a product identifier of a product in which the customer was interested and on which the customer requested for assistance. The unique session identifier is the primary key of the session table 501. The session table 501 is linked to the product table 502, the device table 503, and the sales entity table 504 via the product identifier, the device identifier, and the sales identifier respectively. The product table 502 stores information of all the products of the retailer, for example, respective product identifiers, product names, uniform resource locators (URLs) of the products, departments that hold the products, maximum discounts allowed on the products, etc. The product identifier is the primary key of the product table 502. The device table 503 stores information of all the sales devices deployed by the retailer, for example, respective device identifiers, device specifications, etc. The device identifier is the primary key of the device table 503. The sales entity table 504 stores information of all the sales entities employed by the retailer, for example, respective unique sales identifiers, first and last names of the sales entities, departments to which the sales entities are assigned, etc. The unique sales identifier is the primary key of the sales entity table 504.

The interaction activity table 505 stores information on the live interaction between the customer and the sales entity during the bidirectional, interactive media conferencing session. For example, the interaction activity table 505 stores the session identifier of the bidirectional, interactive media conferencing session, the product identifier of the product being discussed during the bidirectional, interactive media conferencing session, directional information, that is, customer to sales entity or vice versa, of the communication, etc. The session table 501 is linked to the interaction activity table 505 via the session identifier assigned to the bidirectional, interactive media conferencing session, thereby allowing the tracking module 117 of the sales interaction platform 104 exemplarily illustrated in FIG. 1, to track and link interactive sales activities executed between the customer and the sales entity to the bidirectional, interactive media conferencing session. Furthermore, if the sales entity issues one or more promotional coupons to the customer during the bidirectional, interactive media conferencing session, the coupon table 506 stores information of the promotional coupon(s), for example, the coupon identifier, the session identifier of the bidirectional, interactive media conferencing session where the promotional coupon(s) was issued, directional information, that is, customer to sales entity or vice versa, of the communication, etc. The session table 501 is linked to the coupon table 506 via the session identifier assigned to the bidirectional, interactive media conferencing session, thereby allowing the tracking module 117 to track and link usage of one or more promotional coupons by the customer to the bidirectional, interactive media conferencing session.

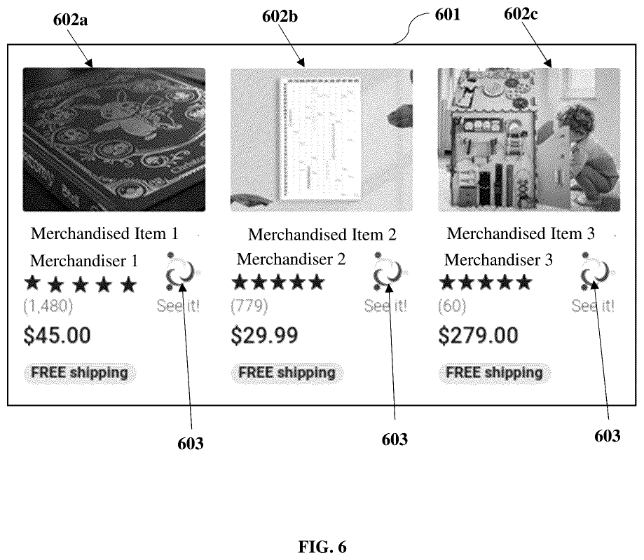

FIG. 6 exemplarily illustrates a screenshot of a portion of a webpage 601 of a retailer, displaying a list of merchandised items 602a, 602b, and 602c and an interface element, for example, an icon 603, disposed proximal to each of the merchandised items 602a, 602b, and 602c for triggering a bidirectional, interactive media conferencing session, for example, a bidirectional, interaction audio-video session configured as an audio-video call. The customer may access the webpage 601 using a browser deployed on a customer device. The icon 603 is a customer-facing interface element configured to be activated by the customer to initiate the audio-video call. In an embodiment, the interface element is configured as a text or another input element such as a menu selection mechanism configured to initiate the audio-video call. If the customer has a question or requires more information on any of the merchandised items 602a, 602b, and 602c, the customer may click on the icon 603 disposed proximal to that particular merchandised item 602a, 602b, or 602c. When the customer clicks on the icon 603, the sales interaction platform opens up a small window that initiates the audio-video call with a sales entity found suitable by the sales interaction platform based on a matching process disclosed in the description of FIG. 1. In an embodiment, on initiating the audio-video call, the sales interaction platform adds control elements to the webpage 601 to help the customer interact with the sales entity.

Consider an example where a retailer hosts a retail store on an online shopping website and displays a list of merchandised items 602a, 602b, and 602c with associated icons 603 for triggering a live interaction between a customer and a sales entity, on a webpage 601 of the online shopping website. The customer accesses the online shopping website through the customer application, for example, a browser application, deployed on a customer device. While browsing on the website, the customer finds a merchandised item of interest, for example, 602a, and notices an icon 603 disposed proximal to the merchandised item 602a that suggests that the customer may view the merchandised item 602a in real time. When the customer clicks on the icon 603, the sales interaction platform opens up a small window in a portion of the browser application, for example, at a bottom right portion or any other portion of the browser application. On the other end, that is, at the physical location of the retail store, a sales entity in the retail store receives an incoming call from the sales interaction platform, which the sales entity accepts. The sales interaction platform launches an application interface or window that connects the sales entity to the customer in an audio-video call. On another pane of the application interface rendered by the sales application, for example, a browser application, deployed on a sales device of the sales entity, the sales application displays the merchandised item 602a of interest whose icon 603 the customer clicked on, in a browser window, so that the sales entity can see what the customer was interested in. The customer and the sales entity talk about the merchandised item 602a, its capabilities, and technical specifications through the audio-video call. During the conversation between the customer and the sales entity, the sales entity brings up an alternative product that the sales entity thinks the customer may prefer on another pane of the application interface. The sales entity clicks on an icon in a tools area of the application interface to send auxiliary information, for example, details of the alternative product, to the customer. On the customer side, their browser application changes to display the alternative product sent by the sales entity. The customer and the sales entity continue their discussion and the sales entity proceeds to send auxiliary information, for example, a page that displays all their different alternatives, to the customer.

The customer views and selects one of the alternatives, and clicks on an icon in the tools area of the application interface to send the page to the sales entity. On the sales device, the browser pane changes to show the customer's selection. The sales entity clicks on another icon in their tools area to create and send, for example, a one-time, time-limited coupon for a specific, requested, discount amount of 11% to the customer. On the browser application on the customer device, the product page displays the 11% discount coupon sent by the sales entity, which is valid, for example, for 24 hours. The customer thanks the sales entity and terminates the audio-video call. The customer then navigates away from the displayed product to other products that they had liked. The customer considers their choices, reviews their discussion with the sales entity, and realizes that the sales entity's recommendation was the right one for them. The customer navigates back to the product page recommended by the sales entity and sees the coupon displayed, but there are only 23 hours and 12 minutes more left to expiry of the coupon. The customer searches for other prices online and realizes that along with the discount coupon given by the sales entity, they have what is close to one of the best prices on the internet, and that too from a reputable retail store. Many of the other comparable prices online match the list price of the product at the retail store. With 5 hours and 37 minutes remaining, the customer completes the transaction and purchases the product, including the one-time coupon provided by the sales entity, convinced that they have got an incredible deal.

Consider another example where a retailer hosts a retail store on an online shopping website and displays a list of merchandised items 602a, 602b, and 602c with associated icons 603 for triggering a live interaction between a customer and a sales entity, on a webpage 601 of the online shopping website. The customer accesses the online shopping website through the customer application, for example, a browser application, deployed on a customer device. While browsing on the website, the customer finds a merchandised item of interest, for example, 602a, and notices an icon 603 disposed proximal to the merchandised item 602a that suggests that the customer may view the merchandised item 602a in real time. When the customer clicks on the icon 603, the sales interaction platform opens up a small window in a portion of the browser application, for example, at a bottom right portion or any other portion of the browser application. On the other end, that is, at the physical location of the retail store, a sales entity in the retail store receives an incoming call from the sales interaction platform, which the sales entity accepts. The sales interaction platform launches an application interface or window that connects the sales entity to the customer in an audio-video call. On another pane of the application interface rendered by the sales application, for example, a browser application, deployed on a sales device of the sales entity, the sales application displays the merchandised item 602a of interest whose icon 603 the customer clicked on, in a browser window, so that the sales entity can see what the customer was interested in. The customer and the sales entity talk about the merchandised item 602a, its capabilities, and technical specifications through the audio-video call.

In an embodiment, the sales interaction platform allows the sales entity to pull in one or more other sales entities to assist the sales entity in the customer interaction, and to provide expertise in their areas of specialization. The sales interaction platform also allows the sales entity to transition the audio-video call to the other sales entities. For example, during the audio-video call, the sales entity realizes that they do not have the kind of detailed technical information that the customer desires, and asks whether they can pull in a colleague in their sales team. If the customer assents, the sales entity uses available tools to look up their colleagues in the retail store, and selects a second sales entity who is available and is known to be knowledgeable in the merchandised item 602a. The sales application on the sales device of the second sales entity rings, the second sales entity accepts, and the sales interaction platform adds the second sales entity to the audio-video call. The second sales entity joins the discussion, and is able to provide all the information on the merchandised item 602a that the customer is interested in. At this point, the previous sales entity sees that the customer is being taken care of, bids the customer goodbye, and exits the audio-video call. The audio-video call continues between the customer and the second sales entity, who continues to help the customer. If the discussion goes beyond the second sales entity's capabilities, or if the second sales entity has to leave for any reason, the second sales entity can similarly pull in a third sales entity to take over the audio-video call and then exit, knowing that the customer is being taken care of. The second sales entity or the third sales entity may then continue the live interaction where the active sales entity and the customer are able to send each other alternatives and suggestions as a basis for the discussion, and discuss them to the satisfaction for the customer. In another embodiment, the sales interaction platform allows the customer to add other people to the audio-video call. This allows the sales entity to communicate and interact with multiple people at the same time. The interaction is identical, in that the sales interaction platform replicates all their interactions with the customer across all the other people on the customer side.

FIGS. 7A-7B exemplarily illustrate different arrangements of configurable areas of an application interface 701 launched on a customer device and a sales device for executing a live interaction between a customer at a customer location and a sales entity at a physical location of a retailer in real time to facilitate sales in a virtual environment. When the bidirectional, interactive media conferencing session is established via an electronic media link between the customer application on a customer device and the sales application on a sales device, the sales interaction platform launches the application interface 701 on the customer device and the sales device as exemplarily illustrated in FIGS. 7A-7B. The sales interaction platform launches the application interface 701, for example, as a main application window, on the customer device and the sales device. In an embodiment, the application interface 701 comprises one or more of multiple configurable areas comprising, for example, a video area 702, a data area 703, and a tools area 704. The video area 702 is configured to allow the customer and a matched sales entity to view each other. The data area 703 is configured to allow exchange of information, for example, sales information, auxiliary information, etc., that supports a conversation between the customer and the matched sales entity. The tools area 704 is configured to assist the exchange of the information in the data area 703, enhance bidirectional communication between the customer and the matched sales entity, add other sales entities and other customers to the bidirectional, interactive media conferencing session, and complete a transaction. The application interface 701 allows any of the configurable areas, for example, the video area 702 and the data area 703, to be resized and positioned at any location on the application interface 701 based on the preferences of the customer and the sales entity, as exemplarily illustrated in FIGS. 7A-7B. In an embodiment, the configurable areas further comprise a coupons area (not shown) configured to manage coupons with associated unique sales identifiers transferred by the matched sales entity to the customer. For purposes of illustration, the detailed description refers to the application interface 701 comprising a video area 702, a data area 703, a tools area 704, and a coupons area; however, the scope of the system and method disclosed herein is not limited to the application interface 701 comprising a video area 702, a data area 703, a tools area 704, and a coupons area, but extends to include other optional and additional areas that provide additional functional capabilities for interaction and communication between the customer and the sales entity.

FIGS. 7A-7B illustrate two exemplary arrangements of features and functionality on the application interface 701 at the customer device of the customer and at the sales device of the matched sales entity. As exemplarily illustrated in FIGS. 7A-7B, the video area 702 is an area of the application interface 701 where participants of a live interaction in a bidirectional, interactive media conferencing session, that is, the customer and the matched sales entity, view each other. The data area 703 is an area of the application interface 701 used by the participants to send associated, auxiliary information to each other, to support the conversation between them on the video area 702. The tools area 704 is an area that provides tools and options configured to be used by both the participants to exchange additional or auxiliary information. One or more of these areas 702, 703, and/or 704 may be hidden at any time if the area(s) is not relevant to the communication, and revealed if the area(s) 702, 703, and/or 704 is activated by either the customer or the sales entity. In an embodiment, when the bidirectional, interactive media conferencing session between the customer and the sales entity is initially established, the application interface 701 displays the merchandised item, for example, the product, that provides context to a service request by the customer in the data area 703.

The tools area 704 provides multiple options that may be used by both the customer and the sales entity to augment and enhance the communication between them. In an embodiment, the tools area 704 provides an option to activate an additional camera and show an output from that camera on the data area 703 of the application interface 701. The sales entity may select the option to turn on the additional camera and show an output from that camera on the data area 703 of the application interface 701 on the customer device. This additional camera may be facing away from the sales entity, which allows the sales entity to show merchandised items on a store shelf. In another embodiment, the tools area 704 provides an option to activate a webpage in the data area 703. Either the customer or the sales entity may select the option to activate a webpage in the data area 703 from the tools area 704. For example, if the sales entity activates a webpage in the data area 703 on the application interface 701 of the sales application deployed on the sales device, the same webpage is then automatically activated and displayed on the application interface 701 of the customer application deployed on the customer device. In an embodiment, the sales entity may use this browser window in the data area 703 to display, for example, alternate products, customer reviews of the product under discussion, etc., to the customer. In another embodiment, the sales entity may use this browser window in the data area 703 to direct the customer to a public website, for example, YouTube® of Google LLC, to display and play popular videos about the product. All actions performed by the sales entity on their data area 703 is replicated on the customer's data area 703, to provide continuing context for their conversation.

In another embodiment, the tools area 704 provides an option to browse through coupons or other promotions relevant to the product under discussion, or an alternate product, in the data area 703 of the application interface 701. The sales entity may select this option from the tools area 704 to browse through coupons or other promotions relevant to the product under discussion, or an alternate product, in the data area 703 of the application interface 701. Once the sales entity selects a coupon that they would like to offer to the customer, the sales entity may send the coupon, for example, using a gesture, to the customer. The sales interaction platform then automatically transfers the coupon to the customer device, where the sales interaction platform utilizes the unique sales identifier of the sales entity offering the coupon to automatically and uniquely encode the coupon before the coupon is delivered to the customer. The customer may receive the coupon in their own data area 703 of the application interface 701. In an embodiment, the customer application allows the customer to activate a coupons area through an identified icon or functionality in the tools area 704 to reveal the received coupon, as well as any other coupon that the customer received in the past.

In another embodiment, the tools area 704 provides an option to complete a purchase transaction. The customer may select this option and activate a functionality to complete a purchase transaction directly. The sales entity who is communicating with the customer may also select this option on the behalf of the customer to complete the purchase transaction. Alternatively, the customer may add the merchandised item to be purchased, to their shopping cart on the original website that was used to activate the application interface 701, and proceed with their online activity. In another embodiment, the tools area 704 provides an option to add other sales entities of a sales team at the physical location of the retailer to the bidirectional, interactive media conferencing session. In this embodiment, the sales entity selects this option to involve other members of the sales team in the conversation using the same sales application. By selecting this option on the tools area 704, the sales entity on an existing call with a customer, may request the sales interaction platform to add other sales entities, product specialists, or any other member of their sales team to the call in progress. On adding other sales entities to the call, the sales interaction platform sends a connection request to the sales device of each of the newly added sales entities. Upon receiving and accepting the connection request from the sales interaction platform, all the members of the sales team may be displayed on the video area 702 of the application interface 701. Any of the sales entities may leave the call at any time, leaving the other members of their sales team to continue their interaction with the customer.

For purposes of illustration, two exemplary arrangements of the video area 702, the data area 703, and the tools area 704 of the application interface 701 at the customer device and the sales device are illustrated in FIGS. 7A-7B; however, the scope of the system and the computer-implemented method disclosed herein is not limited to any particular arrangement of the configurable areas 702, 703, and 704 of the application interface 701, but extends to include multiple different configurations of the video area 702, the data area 703, the tools area 704, and the browser windows that serve as the topic of the conversation, where the sales entity can send suggestions, and where the customer can browse to different products or websites and send them to the sales entity.

The computer-implement method and the system comprising the sales devices, the sale interaction platform, the customer application on each of the customer devices, and the sales application on each of the sales devices, provide an improvement in customer interaction and sales by creating an optimal alternative to a physical interaction in a brick-and-mortar store, thereby allowing customers to see, talk, and interact with sales people in the brick-and-mortar store as they browse through merchandised items in a virtual environment, allowing for a real, live exchange of information that significantly enhances the sales process and aids a customer's decision-making process at the same time. In the system and the computer-implemented method disclosed herein, the design and the flow of interactions between the customer devices, the sales interaction platform, and the sales devices and between the modules of the sales interaction platform are deliberate, designed, and directed. The request for communication received by the sales interaction platform from a customer device at a customer location, via the network, is configured by the sales interaction platform to steer the request towards a finite set of outcomes.

The sales interaction platform implements one or more specific computer programs to direct the customer's request for communication towards a set of end results. The interactions configured by the sales interaction platform allow the sales interaction platform to process the request for communication from the customer device associated with the customer at the customer location; match the customer at the customer location with one of the sales entities at the physical location of the retailer by executing one or more matching algorithms; and from the matching, through the use of other, separate and autonomous computer programs, establish a bidirectional, interactive media conferencing session between the customer device at the customer location and a sales device associated with the matched sales entity at the physical location of the retailer via the network; and execute, through the bidirectional, interactive media conferencing session, one or more interactive sales activities substantially analogous to a physical interaction between the customers and the sales entities at the physical location of the retailer in real time. To perform the above disclosed method steps requires multiple separate computer programs and subprograms, the execution of which cannot be performed by a person using a generic computer with a generic program.

In the system disclosed herein, for each physical store, the sales interaction platform maintains a complete sales entity database of all sales entities who are part of the system, each with their own unique authentication information. The sales interaction platform also maintains metadata associated with each sales entity, that comprises, for example, information about their department, areas of specialization and expertise, etc. The sales interaction platform also maintains a facility by which a sales entity is marked as “available” or “not available” based on their actual availability as disclosed in the description of FIG. 1. In an embodiment, the sales interaction platform also maintains a separate device database of all sales devices, along with the identity of the sales entity using the sales device at a particular time. In another embodiment, the sales interaction platform maintains a consolidated database, for example, the sales entity database for storing both the sales entity information and the sales device information.

When the sales entity starts operating the sales device, the sales application is automatically launched on the sales device. The sales application requests the sales entity to identify and authenticate themselves, for example, by means of a username and password, or a unique pin, or another method for uniquely identifying the sales entity. As soon as the sales entity is authenticated, the sales application on the sales device registers with the sales interaction platform to inform the sales interaction platform that the sales entity is available, and starts running in the background, waiting for incoming requests. When the sales entity has completed their shift or their day's work at the retail store, the sales entity exits the sales application, which then de-registers the sales entity with the sales interaction platform, which then shows that the sales entity is no longer available to take calls.

The interface element, for example, an icon or another interface element on the user interface, for example, a webpage of a website of the retailer, is the starting point of a customer's journey through the system disclosed herein. In an embodiment, the interface element is associated with a particular merchandised item. When the customer clicks on the interface element, the information about which the user wants to talk to a sales entity is conveyed back to the sales interaction platform, along with information, for example, a product identifier (ID), a stock keeping unit (SKU), etc., of the merchandised item in which the customer is interested. The sales interaction platform utilizes an item database or the product database to lookup the department to which the product ID, SKU, etc., belongs. The sales interaction platform then utilizes the department information, along with the database of available sales entities, that is, the sales entity database, to find a suitable match. The sales interaction platform then utilizes the sales device information in the sales entity database or the separate device database, and finds the sales device assigned or being used by the matched sales entity. The sales interaction platform then initiates a bidirectional, interactive media conferencing session in the form of an audio-video call between the customer device and the sales device of the matched sales entity.

The system and the computer-implemented method disclosed herein further allow the sales entity, during the interaction with the customer in the audio-video call, to issue time-limited promotional coupons, with metadata that uniquely identifies the sales entity, to the customer. The sales entity, with an active item page on a sales device, selects an option to send a coupon to the customer. The sales application on the sales device requests for additional coupon information comprising, for example, the requested discount percentage, the duration of the coupon, etc. When the sales entity enters and submits the requested coupon information through the sales application on the sales device, the sales application sends the coupon request to the sales interaction platform. The sales interaction platform receives the coupon request and executes algorithms to determine whether the requested discount percentage may be allowed for the merchandised item.

A retailer may internally have published guidelines that specify the maximum discount allowed for every merchandised item, based upon the item category, manufacturers of the merchandised items, and any discounts negotiated between the manufacturers and the retailer. In an embodiment, the sales interaction platform performs a lookup of the product table 502 exemplarily illustrated in FIG. 5, to determine the maximum discount allowed for a merchandised item. In an embodiment, the sales interaction platform matches the discount requested by the sales entity based upon their interaction with the customer to the maximum discount allowed for that merchandised item, to determine whether the discount can be offered to the customer. If the requested discount by the sales entity is within the published guidelines, then the sales interaction platform allows the coupon to be issued to the customer. If the discount percentage requested is within permissible limits, the sales interaction platform generates a unique coupon, stores the unique coupon with the requested discount percentage and the requested active lifetime of the coupon in the coupon database, and associates the unique coupon with the sales entity who requested the coupon. The sales interaction platform then sends the unique coupon to the customer, for example, in the coupons area of the application interface where the unique coupon is received and displayed on the merchandised item for which the unique coupon was issued.

The focus of the system and the computer-implemented method disclosed herein is on an improvement to customer interaction and sales allowing for a real live exchange of information that significantly enhances the sales process and aids a customer's decision-making process, and not on economic or other tasks for which a generic computer is used in its ordinary capacity. Accordingly, the system and the computer-implemented method disclosed herein are not directed to an abstract idea. Rather, the system and the computer-implemented method disclosed herein are directed to a specific improvement to the way the sales interaction platform operates with the customer devices and the sales devices, embodied in, the method steps disclosed in the descriptions of FIGS. 1-4. In various embodiments, the focus of the system and the computer-implemented method disclosed herein is directed to creating the end-to-end connectivity between the customer device and the sales device(s), maintaining the availability status of the sales entities, and implementing a transit hub for conveying information from the customer to the sales entity and from the sales entity to the customer as they send alternatives, webpages, and other auxiliary information to each other.

The system and the computer-implemented method disclosed herein extend the experience of shopping in the physical world to the virtual environment. The system and the computer-implemented method disclosed herein utilize internet communication channels along with brick-and-mortar stores and sales entities, for example, sales people who work at the brick-and-mortar stores, to allow prospective customers at their respective customer locations to interact with sales people in a physical store in real time, that approximates as closely as possible to a physical visit to the physical store. In the embodiments disclosed herein, the system is used to enhance an interaction with a customer and provide a method for retail organizations and other outlets to deepen their relationship with their customers, and to more conclusively effect a sale or a transaction. The system and the computer-implemented method disclosed herein also increase relevance and effectiveness of sales people in the entire retail industry. Simultaneous to providing sales people with increased visibility within a retail organization and increased and better contact with the customers, the system and the computer-implemented method disclosed herein also allow for quantifiably and optimally measuring effectiveness of the sales people, for training and enhancing their effectiveness in communicating with the customers and for tracking their continued improvement.

The embodiments of the system and the computer-implemented method disclosed herein that are embedded within a website of an online retailer allow a customer who is visiting the website to perform a user action, for example, a click action, to initiate a secure, bidirectional, interactive media conferencing session with a sales entity in a physical brick-and-mortar location. The secure, bidirectional, interactive media conferencing session comprises an interactive video conference that is initiated between the customer system and the sales entity system. The system and the computer-implemented method disclosed herein allow the customer to be directly connected, through the interactive video conference, to the sales entity in a retail or display location by performing the user action on a webpage of the website. The secure, bidirectional, interactive media conferencing session allows the customer to talk to the sales entity, to ask questions, interactively view merchandised items, and perform any other activity that is analogous to a physical store visit. In response, the secure, bidirectional, interactive media conferencing session allows the sales entity to initiate interactive sales activities to engage the customer, including transmitting, to the customer, auxiliary information comprising, for example, alternate product recommendations, product videos, ratings studies, etc., that approximate as closely as possible to a real physical interaction between a sales person of a sales team and the prospective customer.

The secure, bidirectional, interactive media conferencing session also allows the sales entity, during the course of the interaction with the customer, to send personalized, time-limited promotional coupons with metadata configured to be uniquely identified with the identity of the sales entity, to the customer. The sales interaction platform tracks and links back a future use of the time-limited promotional coupons by the customer, even in a completely different session or from a customer device different from the customer device used for the interaction with the sales entity, to the original interaction between the sales entity and the customer. The ability of both the customer as well as the sales entity to be able to send webpages, links, and audio-visual material to each other, when used along with the interactive audio-video link between the customer and the sales entity, combines elements of online product research and discovery with support provided by informed and trained sales entities.

The system and the computer-implemented method disclosed herein blend the best of both the physical and virtual or internet worlds, through the combined use of a media connection, for example, an audio-visual connection, between a customer and a sales entity. The audio-visual link defining the audio-visual connection allows a sales entity to provide interactive customer assistance through the internet that parallels a physical store visit by the customer and an interaction with a customer service associate in the physical store. The system and the computer-implemented method disclosed herein extend the use of the audio-visual connection with other functionality that extends the capability to include online activities, for example, interactive browsing of product alternatives, customer reviews, and other elements such as videos, thereby allowing the experience to straddle the physical and the virtual or internet worlds. Furthermore, the system and the computer-implemented method disclosed herein extend the above-disclosed functionalities with other functionality associated with handling customized promotional coupons between the sales entity and the customer, thereby improving customer experience that extends past the completion of the bidirectional, interactive media conferencing session with the sales entity.

The system and the computer-implemented method disclosed herein allow quick adoption of an online sales model or an online storefront model by retailers such as online retailers and even retailers that have a physical infrastructure, thereby enhancing the benefit to retailers on the internet as available inventory may be shown to customers irrespective of their physical locations, thereby invalidating the need to develop and maintain distribution channels, and locate physical items in close proximity to a customer in order to display the physical items to the customer. This allows a retailer to be able to maintain a substantially large number of products and have a much richer inventory, while simultaneously avoiding the additional expense of moving the available inventory to each physical location. The system and the computer-implemented method disclosed herein provide a direct and linear correlation between a customer's interaction with a helpful and informed sales entity and a subsequent sale, that may immediately follow the interaction.

It is apparent in different embodiments that the various methods, algorithms, and computer-readable programs disclosed herein are implemented on non-transitory, computer-readable storage media appropriately programmed for computing devices. The non-transitory, computer-readable storage media participate in providing data, for example, instructions that are read by a computer, a processor, or a similar device. In different embodiments, the “non-transitory, computer-readable storage media” also refer to a single medium or multiple media, for example, a centralized database, a distributed database, and/or associated caches and servers that store one or more sets of instructions that are read by a computer, a processor, or a similar device. The “non-transitory, computer-readable storage media” also refer to any medium capable of storing or encoding a set of instructions for execution by a computer, a processor, or a similar device and that causes a computer, a processor, or a similar device to perform any one or more of the steps of the method disclosed herein. In an embodiment, the computer programs that implement the methods and algorithms disclosed herein are stored and transmitted using a variety of computer-readable media in various manners. In an embodiment, hard-wired circuitry or custom hardware is used in place of, or in combination with, software instructions for implementing the processes of various embodiments. Therefore, the embodiments are not limited to any specific combination of hardware and software. Various aspects of the embodiments disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the embodiments disclosed herein are implemented as programmed elements, or non-programmed elements, or any suitable combination thereof.

Where databases are described such as the customer database 111, the sales entity database 112, the interaction database 116, the product database 119, the device database 120, and the coupon database 121 exemplarily illustrated in FIG. 1, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. In an embodiment, object methods or behaviors of a database are used to implement various processes such as those disclosed herein. In another embodiment, the databases are, in a known manner, stored locally or remotely from a device that accesses data in such a database. In embodiments where there are multiple databases, the databases are integrated to communicate with each other for enabling simultaneous updates of data linked across the databases, when there are any updates to the data in one of the databases.

The embodiments disclosed herein are configured to operate in a network environment comprising one or more computers that are in communication with one or more devices via a network. In an embodiment, the computers communicate with the devices directly or indirectly, via a wired medium or a wireless medium such as the Internet, satellite internet, a local area network (LAN), a wide area network (WAN) or the Ethernet, or via any appropriate communications mediums or combination of communications mediums. Each of the devices comprises processors that are adapted to communicate with the computers. In an embodiment, each of the computers is equipped with a network communication device, for example, a network interface card, a modem, or other network connection device suitable for connecting to a network. Each of the computers and the devices executes an operating system. While the operating system may differ depending on the type of computer, the operating system provides the appropriate communications protocols to establish communication links with the network. Any number and type of machines may be in communication with the computers.

The embodiments disclosed herein are not limited to a particular computer system platform, processor, operating system, or network. One or more of the embodiments disclosed herein are distributed among one or more computer systems, for example, servers configured to provide one or more services to one or more client computers, or to perform a complete task in a distributed system. For example, one or more of embodiments disclosed herein are performed on a client-server system that comprises components distributed among one or more server systems that perform multiple functions according to various embodiments. These components comprise, for example, executable, intermediate, or interpreted code, which communicate over a network using a communication protocol. The embodiments disclosed herein are not limited to be executable on any particular system or group of systems, and are not limited to any particular distributed architecture, network, or communication protocol.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A system for executing a live interaction between a customer at a customer location and a sales entity at a physical location of a retailer in real time to facilitate sales in a virtual environment, the system comprising:
a plurality of sales devices configured for use by sales entities at the physical location of the retailer; and
a sales interaction platform communicatively coupled to the sales devices and to a plurality of customer devices associated with customers, via a network, the sales interaction platform comprising:
at least one processor;
a memory unit operably and communicatively coupled to the at least one processor and configured to store computer program instructions executable by the at least one processor;
one or more databases configured to store customer information, sales entity information, sales device information, and information on the live interaction between the sales entities and the customers; and
one or more modules defining the computer program instructions, which when executed by the at least one processor, cause the at least one processor to:
receive a request for communication from one of the customer devices associated with one of the customers at the customer location, via the network;
match the one of the customers at the customer location with one of the sales entities at the physical location of the retailer by executing one or more matching algorithms;
establish a bidirectional, interactive media conferencing session between the one of the customer devices at the customer location and one of the sales devices associated with the matched one of the sales entities at the physical location of the retailer via the network; and
execute, through the bidirectional, interactive media conferencing session, one or more of a plurality of interactive sales activities substantially analogous to a physical interaction between the customers and the sales entities at the physical location of the retailer in real time, wherein the interactive sales activities comprise rendering auxiliary information with metadata configured to be uniquely identified with a unique sales identifier of the matched one of the sales entities, to the one of the customer devices.

2. The system of claim 1, further comprising a client application deployed on each of the customer devices and configured to identify each of the customers to the sales interaction platform through a unique customer identifier assigned to the client application, wherein the bidirectional, interactive media conferencing session is established via an electronic media link between the client application on the one of the customer devices and a client application deployed on the one of the sales devices for bidirectional interactivity therebetween, and wherein each of the sales devices is a dedicated computing device comprising one or more cameras and a microphone, configured to connect the sales entities to the sales interaction platform via the network.

3. The system of claim 2, wherein, when the bidirectional, interactive media conferencing session is established via the electronic media link between the client application on the one of the customer devices and the client application deployed on the one of the sales devices, one or more of the computer program instructions defined by the one or more modules of the sales interaction platform, when executed by the at least one processor, cause the at least one processor to launch an application interface on the one of the customer devices and the one of the sales devices, wherein the application interface comprises one or more of a plurality of configurable areas, the configurable areas comprising:
a video area configured to allow the one of the customers and the matched one of the sales entities to view each other;
a data area configured to allow exchange of information that supports a conversation between the one of the customers and the matched one of the sales entities;
a tools area configured to assist the exchange of the information in the data area, enhance bidirectional communication between the one of the customers and the matched one of the sales entities, add other sales entities and other customers to the bidirectional, interactive media conferencing session, and complete a transaction; and
a coupons area configured to manage coupons with associated unique sales identifiers transferred by the matched one of the sales entities to the one of the customers.

4. The system of claim 2, wherein one or more of the computer program instructions defined by the one or more modules of the sales interaction platform, when executed by the at least one processor, cause the at least one processor to utilize the unique customer identifier to: (a) connect to the identified each of the customers at any time; and (b) store the customer information and the information of the live interaction between the each of the customers and the sales entities.

5. The system of claim 1, wherein one or more of the computer program instructions defined by the one or more modules of the sales interaction platform, when executed by the at least one processor, cause the at least one processor to: (a) identify and track each of the sales entities through a unique sales identifier assigned thereto; and (b) utilize the unique sales identifier to collect and store the sales entity information comprising geographical locations of the each of the sales entities, one or more departments, one or more areas of expertise, and a complete history of interactions of the each of the sales entities with the customers, wherein the complete history of interactions comprises information about coupons, discounts, special offers, considerations that have been advanced to the customers by the each of the sales entities, and associated customer redemption information.

6. The system of claim 1, wherein one or more of the computer program instructions defined by the one or more modules of the sales interaction platform, when executed by the at least one processor, cause the at least one processor to: (a) identify and track each of the sales devices through a unique device identifier assigned thereto; (b) utilize the unique device identifier to check whether the each of the sales devices is connected to the sales interaction platform; and (c) utilize the unique device identifier for contacting the each of the sales devices at any time.

7. The system of claim 1, wherein the interactive sales activities are configured to enhance the sales and aid decision-making of the customers, and wherein the interaction sales activities further comprise:
a bidirectional question-answer session between the one of the customers and the matched one of the sales entities;
bidirectional communication and exchange of sales information related to merchandised items, promotions, and offers of the retailer between the one of the customers and the matched one of the sales entities;
interactive viewing, by the one of the customers, of the merchandised items managed by the retailer; and
customer engagement activities associated with the auxiliary information comprising one or more of promotional coupons, alternative product recommendations, product media, ratings, studies, webpages, hyperlinks, and media content, to engage the one of the customers.

8. The system of claim 7, wherein one or more of the computer program instructions defined by the one or more modules of the sales interaction platform, when executed by the at least one processor, cause the at least one processor to track and link usage of the promotional coupons by the one of the customers to the bidirectional, interactive media conferencing session using the metadata.

9. The system of claim 1, wherein one or more of the computer program instructions defined by the one or more modules of the sales interaction platform, when executed by the at least one processor, cause the at least one processor to:
render an interface element associated with each of a plurality of merchandised items managed by the retailer on a user interface rendered by the retailer in the virtual environment; and
on receiving a user action on the interface element associated with any of the merchandised items displayed on the user interface, establishing the bidirectional, interactive media conferencing session associated with the any of the merchandised items between the one of the customer devices at the customer location and the one of the sales devices at the physical location of the retailer via the network.

10. The system of claim 1, wherein the one or more matching algorithms define criteria configured to match the one of the customers at the customer location with the one of the sales entities at the physical location of the retailer, wherein the criteria based on which the matching is performed comprise availability criteria of the sales entities and suitability criteria of the sales entities, and wherein the suitability criteria comprise one or more of domains of expertise of the sales entities, the physical location of the retailer, the customer location, geographical location of the sales entities, interaction history, proximity of the sales entities to the customer location of the one of the customers determined using global positioning system data, department of a merchandised item of interest derived from a unique item identifier, the customer information, demographic information, historical information of previous bidirectional, interactive media conferencing sessions conducted between the one of the customers and a corresponding one of the sales entities, and preferences of the customers and the sales entities, and wherein the historical information of the previous bidirectional, interactive media conferencing sessions comprises one or more of number and length of the previous bidirectional, interactive media conferencing sessions.

11. The system of claim 1, wherein one or more of the computer program instructions defined by the one or more modules of the sales interaction platform, when executed by the at least one processor, cause the at least one processor to add another one or more of the sales entities to the bidirectional, interactive media conferencing session to one or more of: assist the matched one of the sales entities; provide expertise of the another one or more of the sales entities in the live interaction with the one of the customers; and allow the matched one of the sales entities to transition the bidirectional, interactive media conferencing session to the another one or more of the sales entities.

12. The system of claim 1, wherein one or more of the computer program instructions defined by the one or more modules of the sales interaction platform, when executed by the at least one processor, cause the at least one processor to add another one or more of the customers to the bidirectional, interactive media conferencing session to allow the matched one of the sales entities to interact with multiple customers simultaneously and execute the one or more of the interactive sales activities identically across the multiple customers.

13. The system of claim 1, wherein the bidirectional, interactive media conferencing session is one of an interactive video conferencing session, an interactive audioconferencing session, an interactive audio-visual conferencing session, an interactive visual conferencing session with a textual translation of audio content, and an interactive multimedia conferencing session.

14. The system of claim 1, wherein the sales entities comprise sales persons employed at the physical location of the retailer to serve physical customers who visit the physical location of the retailer and virtual customers who contact the sales entities via the sales interaction platform.

15. The system of claim 1, wherein one or more of the computer program instructions defined by the one or more modules of the sales interaction platform, when executed by the at least one processor, cause the at least one processor to determine effectiveness of the sales entities for training the sales entities, enhancing the effectiveness of the sales entities in communicating with the customers, and tracking continued improvement of the sales entities.

16. A computer-implemented method employing a sales interaction platform defining computer program instructions executable by at least one processor for executing a live interaction between a customer at a customer location and a sales entity at a physical location of a retailer in real time to facilitate sales in a virtual environment, the computer-implemented method comprising:
receiving a request for communication from a customer device associated with the customer at the customer location, via a network;
matching the customer at the customer location with one of a plurality of sales entities at the physical location of the retailer by executing one or more matching algorithms;
establishing a bidirectional, interactive media conferencing session between the customer device at the customer location and a sales device associated with the matched one of the sales entities at the physical location of the retailer via the network; and
executing, through the bidirectional, interactive media conferencing session, one or more of a plurality of interactive sales activities substantially analogous to a physical interaction between customers and the sales entities at the physical location of the retailer in real time, wherein the interactive sales activities comprise rendering auxiliary information with metadata configured to be uniquely identified with a unique sales identifier of the matched one of the sales entities, to the customer device.

17. The computer-implemented method of claim 16, wherein the bidirectional, interactive media conferencing session is established via an electronic media link between a client application deployed on the customer device and a client application deployed on the sales device for bidirectional interactivity therebetween, wherein the client application on the customer device is configured to identify the customer to the sales interaction platform through a unique customer identifier assigned to the client application, and wherein the sales device is a dedicated computing device comprising one or more cameras and a microphone, configured to connect one of the sales entities to the sales interaction platform via the network.

18. The computer-implemented method of claim 17, further comprising utilizing the unique customer identifier to: (a) connect to the identified customer at any time; and (b) store customer information and information of the live interaction between the customer and the matched one of the sales entities.

19. The computer-implemented method of claim 16, further comprising:
identifying and tracking each of the sales entities through a unique sales identifier assigned thereto; and
utilizing the unique sales identifier to collect and store sales entity information comprising geographical locations of the each of the sales entities, one or more departments, one or more areas of expertise, and a complete history of interactions of the each of the sales entities with the customers, wherein the complete history of interactions comprises information about coupons, discounts, special offers, considerations that have been advanced to the customer by the each of the sales entities, and associated customer redemption information.

20. The computer-implemented method of claim 16, further comprising:
identifying and tracking the sales device through a unique device identifier assigned thereto;
utilizing the unique device identifier to check whether the sales device is connected to the sales interaction platform; and
utilizing the unique device identifier for contacting the sales device at any time.

21. The computer-implemented method of claim 16, wherein the interactive sales activities are configured to enhance the sales and aid decision-making of the customer, and wherein the interaction sales activities further comprise:
a bidirectional question-answer session between the customer and the matched one of the sales entities;
bidirectional communication and exchange of sales information related to merchandised items, promotions, and offers of the retailer between the customer and the matched one of the sales entities;
interactive viewing, by the customer, of the merchandised items managed by the retailer; and
customer engagement activities associated with the auxiliary information comprising one or more of promotional coupons, alternative product recommendations, product media, ratings, studies, webpages, hyperlinks, and media content, to engage the customer.

22. The computer-implemented method of claim 21, further comprising tracking and linking usage of the promotional coupons by the customer to the bidirectional, interactive media conferencing session using the metadata.

23. The computer-implemented method of claim 16, wherein the one or more matching algorithms define criteria configured to match the customer at the customer location with the one of the sales entities at the physical location of the retailer, wherein the criteria based on which the matching is performed comprise availability criteria of the sales entities and suitability criteria of the sales entities, and wherein the suitability criteria comprise one or more of domains of expertise of the sales entities, the physical location of the retailer, the customer location, geographical location of the sales entities, interaction history, proximity of the sales entities to the customer location of the customer determined using global positioning system data, department of a merchandised item of interest derived from a unique item identifier, the customer information, demographic information, historical information of previous bidirectional, interactive media conferencing sessions conducted between the customer and a corresponding one of the sales entities, and preferences of the customer and the sales entities, and wherein the historical information of the previous bidirectional, interactive media conferencing sessions comprises one or more of number and length of the previous bidirectional, interactive media conferencing sessions.

24. The computer-implemented method of claim 16, further comprising one or more of:
adding another one or more of the sales entities to the bidirectional, interactive media conferencing session to one or more of: assist the matched one of the sales entities; provide expertise of the another one or more of the sales entities in the live interaction with the one of the customers; and allow the matched one of the sales entities to transition the bidirectional, interactive media conferencing session to the another one or more of the sales entities; and
adding another one or more of the customers to the bidirectional, interactive media conferencing session to allow the matched one of the sales entities to interact with multiple customers simultaneously and execute the one or more of the interactive sales activities identically across the multiple customers.

25. The computer-implemented method of claim 16, wherein the bidirectional, interactive media conferencing session is one of an interactive video conferencing session, an interactive audioconferencing session, an interactive audio-visual conferencing session, an interactive visual conferencing session with a textual translation of audio content, and an interactive multimedia conferencing session.
